(19) United States
(12) Patent Application Publication
(10) Pub. No.: US 2025/0260687 A1
(43) Pub. Date: Aug. 14, 2025

(54) ELECTRONIC DEVICE AND SYSTEM INCLUDING SAME

(71) Applicant: LG ELECTRONICS INC., Seoul (KR)

(72) Inventors: Seunghye Park, Seoul (KR); Gowoon Choi, Seoul (KR); Seonghak Lee, Seoul (KR); Sangseok Lee, Seoul (KR); Taejoon Kim, Seoul (KR); Jeongyong Park, Seoul (KR); Jungjae Lee, Seoul (KR)

(73) Assignee: LG ELECTRONICS INC., Seoul (KR)

(21) Appl. No.: 18/939,810

(22) Filed: Nov. 7, 2024

(30) Foreign Application Priority Data
Feb. 8, 2024 (KR) 10-2024-0019974
Jul. 31, 2024 (WO) PCT/KR2024/011226

(51) Int. Cl. H04L 9/40; G06F 9/445; G10L 15/22; G10L 17/22

(52) U.S. Cl. CPC H04L 63/0861; G06F 9/4451; G10L 15/22; G10L 17/22

(57) ABSTRACT

An electronic device and a system including the same are disclosed. The electronic device includes a network interface configured to communicate with a server, a user input interface configured to transmit a signal related to an input, and a controller, wherein the controller is configured to, upon receiving a speech signal related to input speech, determine whether a user who has uttered the speech is related to a first user account logged in to the server, log in to the server with a second user account related to the user who has uttered the input speech based on the user who has uttered the input speech not being related to the first user account, and update setting values preset for the electronic device to setting values related to the second user account based on logging in to the server with the second user account.

### BACKGROUND OF THE INVENTION

### 1. Field of the invention

The present disclosure relates to an electronic device and a system including the same, and more specifically, to an electronic device and a system including the same that utilize speech recognition technology.

### 2. Description of the Related Art

With the recent development of technology, research on speech recognition technology for processing speech is being actively conducted. In particular, research on speech recognition technology, which began with smartphones, is being conducted widely in various fields related to user convenience, such as vehicles, as well as home appliances used at home and in offices.

Speech recognition technology is commonly used when a user controls an electronic device using his or her voice. For example, when a user utters a command to control an electronic device, the electronic device may directly recognize and process user's speech and operate according to the command related to the speech, or may send the speech to a server that processes speech and then operate according to a command related to the speech received from the server.

Meanwhile, services or functions provided through electronic devices are becoming increasingly diverse. Additionally, users register accounts for various services and then use the services by logging in with the registered account. In this case, service providers use user information managed for each account to provide optimal functions or information tailored to the user.

Conventionally, when attempting to log in to use a service, a user needs to directly input account information, for example, an identification (ID) and/or a password of the account. However, it is inconvenient for a user to input account information one by one into various services. Additionally, if a user remains logged in to eliminate the inconvenience of inputting account information, security problems such as access to the user's account information by others may occur. Additionally, when multiple users use one electronic device together, there is a problem that multiple users need to input their account information and log in each time they use a service.

### SUMMARY OF THE INVENTION

Therefore, the present disclosure has been made in view of the above problems, and it is an object of the present disclosure to solve the above-described problems and other problems.

It is another object of the present disclosure to provide an electronic device and a system including the same capable of registering identification information on user voice in a user account.

It is a further object of the present disclosure to provide an electronic device and a system including the same capable of identifying a user based on user voice.

It is a further object of the present disclosure to provide an electronic device and a system including the same capable of allowing a user to log in to a user account identified based on user voice.

It is a further object of the present disclosure to provide an electronic device and a system including the same capable of accurately notifying a user of switching of a logged-in user account.

It is a further object of the present disclosure to provide an electronic device and a system including the same capable of using setting values optimized for a logged-in user account.

It is a further object of the present disclosure to provide an electronic device and a system including the same capable of providing a user interface optimized for an input method used by a user.

In accordance with the present disclosure, the above and other objects can be accomplished by the provision of an electronic device including a network interface configured to communicate with a server, a user input interface configured to transmit a signal related to an input, and a controller, wherein the controller is configured to, upon receiving a speech signal related to input speech, determine whether a user who has uttered the speech is related to a first user account logged in to the server, log in to the server with a second user account related to the user who has uttered the input speech based on the user who has uttered the input speech not being related to the first user account, and update setting values preset for the electronic device to setting values related to the second user account based on logging in to the server with the second user account.

In accordance with another aspect of the present disclosure, there is provided a system including an electronic device, and a server, wherein the electronic device is configured to transmit data including a speech signal related to input speech uttered by a user to the server, determine whether the user who has uttered the input speech is related to a first user account logged in to the server based on a result of processing the speech signal received from the server, log in to the server with a second user account related to the user who has uttered the input speech based on the user who has uttered the input speech not being related to the user account logged in to the server, and update setting values preset for the electronic device to setting values related to the second user account based on logging in to the server with the second user account, and the server is configured to generate identification information related to the speech signal included in the data received from the electronic device, determine predetermined identification information related to the identification information related to the speech signal from among identification information mapped to user identification information related to user accounts, stored in a database of the server, and transmit a result of processing the speech signal including predetermined user identification information mapped to the predetermined identification information to the electronic device.

Additional scope of applicability of the present disclosure will become from the detailed apparent description that follows. However, since various changes and modifications within the scope of the present disclosure may be clearly understood by those skilled in the art, the detailed description and specific embodiments such as preferred embodiments of the present disclosure should be understood as being given only as examples.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram illustrating a system according to an embodiment of the present disclosure;

FIG. 2 is an internal block diagram of an electronic device of FIG. 1;

FIG. 3 is a diagram referenced in description of a server of FIG. 1;

FIG. 4 is a block diagram illustrating a configuration of a server according to an embodiment of the present disclosure;

FIG. 5 is a diagram illustrating an example of converting a speech signal into a power spectrum according to an embodiment of the present disclosure;

FIG. 6 is a block diagram illustrating the configuration of a controller for speech recognition and synthesis of an electronic device, according to an embodiment of the present disclosure;

FIG. 7 is a flowchart of a method of operating an electronic device according to an embodiment of the present disclosure;

FIG. 8 is a flowchart of a method of operating a system according to an embodiment of the present disclosure;

FIG. 9 to FIG. 13 are diagrams referenced in description of a process of registering identification information on a user voice in a user account according to an embodiment of the present disclosure;

FIG. 14 and FIG. 15 are flowcharts of a method of operating an electronic device according to an embodiment of the present disclosure; and

FIG. 16 to FIG. 28 are diagrams referenced in description of responses to user voice according to various embodiments of the present disclosure.

### DETAILED DESCRIPTION OF THE PREFERRED EMBODIMENTS

Hereinafter, the present disclosure will be described in detail with reference to the attached drawings. In the drawings, parts not related to description are omitted in order to clearly and briefly describe the present disclosure, and identical or extremely similar parts are denoted by the same reference numerals throughout the specification.

The suffixes “module” and “part” for components used in the following description are simply given in consideration of the ease of writing this specification and do not have any particularly important meaning or role. Accordingly, the terms “module” and “part” may be used interchangeably.

In the present disclosure, it will be further understood that the term “comprise” or “include” specifies the presence of a stated feature, figure, step, operation, component, part or combination thereof, but does not preclude the presence or addition of one or more other features, figures, steps, operations, components, or combinations thereof.

Further, in this specification, the terms “first” and/or “second” are used to describe various components, but such components are not limited by these terms. The terms are used to discriminate one component from another component.

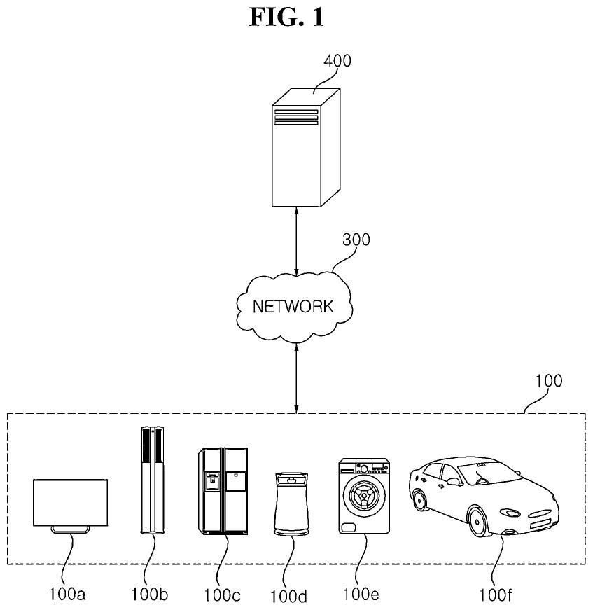

FIG. 1 is a diagram illustrating a system according to various embodiments of the present disclosure.

Referring to FIG. 1, the system 10 may include an electronic device 100 and/or a server 400.

The electronic device 100 may transmit/receive data to/from at least one server 400. For example, the electronic device 100 may transmit/receive data to/from the at least one server 400 via a network 300 such as the Internet.

According to an embodiment, the at least one server 400 may include a server that performs speech recognition, a server that processes data using a super-giant artificial intelligence model, a server that provides content, and the like.

The electronic device 100 may include an image display device 100a, an air conditioner 100b, a refrigerator 100c, an air purifier 100d, a washing machine 100e, a vehicle 100f, and the like. Although the electronic device 100 is an image display device 100a in the present disclosure, the present disclosure is not limited thereto.

The image display device 100a may be a device that processes and outputs images. The image display device 100a is not particularly limited as long as it can output a screen related to video signals, such as a TV, a laptop computer, or a monitor.

The image display device 100a may receive a broadcast signal, process the same, and output a processed broadcast image. When the image display device 100a receives a broadcast signal, the image display device 100a may correspond to a broadcast reception device.

The image display device 100a may receive broadcast signals wirelessly through an antenna, or may receive broadcast signals through a cable. For example, the image display device 100a may receive terrestrial broadcast signals, satellite broadcast signals, cable broadcast signals, and Internet protocol Television (IPTV) broadcast signals.

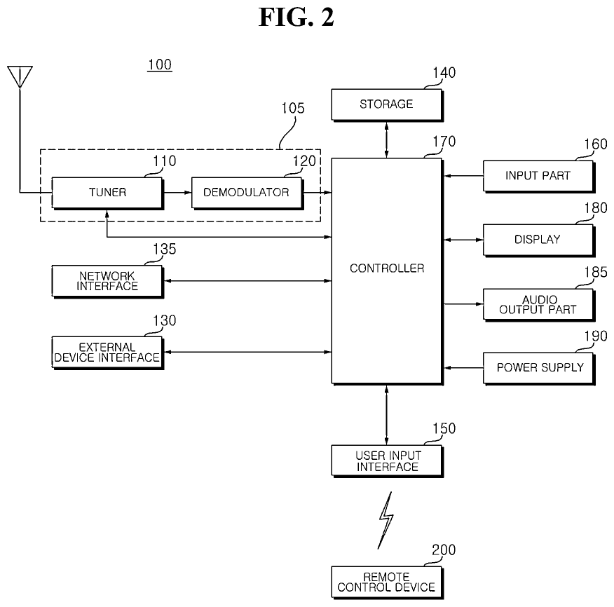

FIG. 2 is an internal block diagram of the electronic device of FIG. 1.

Referring to FIG. 2, the electronic device 100 may include a broadcast receiver 105, an external device interface 130, a network interface 135, a storage 140, a user input interface 150, an input part 160, a controller 170, a display 180, an audio output part 185, and/or a power supply 190.

The broadcast receiver 105 may include a tuner 110 and a demodulator 120.

Meanwhile, the electronic device 100 may include only the broadcast receiver 105 and the external device interface 130 among the broadcast receiver 105, the external device interface 130, and the network interface 135. That is, the electronic device 100 may not include the network interface 135.

The tuner 110 may select a broadcast signal related to a channel selected by a user or broadcast signals of all previously stored channels among broadcast signals received through an antenna (not shown) or a cable (not shown). The tuner 110 may convert the selected broadcast signals into intermediate frequency signals or baseband video or audio signals.

For example, if a selected broadcast signal is a digital broadcast signal, the tuner 110 may convert the selected broadcast signal into a digital IF signal (DIF), and if the selected broadcast signal is an analog broadcast signal, convert the same into an analog baseband video or audio signal (CVBS/SIF). That is, the tuner 110 may process digital broadcast signals or analog broadcast signals. The analog base band video or audio signal (CVBS/SIF) output from the tuner 110 may be directly input to the controller 170.

Meanwhile, the tuner 110 may sequentially select broadcast signals of all of stored broadcast channels through a channel memory function among received broadcast signals and convert the same into intermediate frequency signals or baseband video or audio signals.

The tuner 110 may include a plurality of tuners in order to receive broadcast signals of a plurality of channels. Alternatively, a single tuner that simultaneously receives broadcast signals of a plurality of channels may also be adopted.

The demodulator 120 may receive a digital IF signal (DIF) converted by the tuner 110 and perform a demodulation operation.

The demodulator 120 may output a stream signal TS after performing demodulation and channel decoding. Here, the stream signal may be a multiplexed video signal, audio signal, or data signal.

The stream signal output from the demodulator 120 may be input to the controller 170. After performing demultiplexing and video/audio signal processing, the controller 170 may output video through the display 180 and output audio through the audio output part 185.

The external device interface 130 may transmit/receive data to/from a connected external device. To this end, the external device interface 130 may include an A/V input/output part (not shown).

The external device interface 130 may be connected to external devices such as a digital versatile disc (DVD) player, a Blu-ray player, a game console, a camera, a camcorder, a computer (laptop), a set-top box, and the like in wired/wireless manners, and may also perform input/output operations with respect to external devices.

In addition, the external device interface 130 may establish a communication network with respect to various remote control devices 200 to receive control signals related to the operation of the electronic device 100 from the remote control devices 200 or to transmit data related to the operation of the electronic device 100 to the remote control devices 200.

The A/V input/output part may receive video and audio signals from an external device. For example, the A/V input/output part may include an Ethernet terminal, a USB terminal, a composite video banking Sync (CVBS) terminal, a component terminal, an S-video terminal (analog), a digital visual interface (DVI) terminal, a high definition multimedia interface (HDMI) terminal, a mobile high-definition link (MHL) terminal, an RGB terminal, a D-SUB terminal, an IEEE 1394 terminal, an SPDIF terminal, a liquid HD terminal, and the like. Digital signals input through these terminals may be transmitted to the controller 170. Here, analog signals input through the CVBS terminal and the S-video terminal may be converted into digital signals through an analog-to-digital converter (not shown) and transmitted to the controller 170.

The external device interface 130 may include a wireless communication part (not shown) for short-distance wireless communication with other electronic devices. The external device interface 130 may exchange data with a neighboring mobile terminal through the wireless communication part. For example, the external device interface 130 may receive device information, executing application information, application images, and the like from the mobile terminal in a mirroring mode.

The external device interface 130 may perform short-range wireless communication using Bluetooth, radio frequency identification (RFID), infrared data association (IrDA), ultra-wideband (UWB), ZigBee, and the like.

The network interface 135 may provide an interface for connecting the electronic device 100 to a wired/wireless network including the Internet.

The network interface 135 may include a communication module (not shown) for connection to a wired/wireless network. For example, the network interface 135 may include a communication module for a wireless LAN (WLAN) (Wi-Fi), wireless broadband (WiBro), world interoperability for microwave access (WiMax), and high speed downlink packet access (HSDPA).

The network interface 135 may transmit/receive data to/from other users or other electronic devices through a connected network or another network linked to the connected network.

The network interface 135 may receive web content or data provided by content providers or network operators. That is, the network interface 135 may receive content such as movies, advertisements, games, VOD, and broadcasting and information related thereto provided from content providers or network providers through networks.

The network interface 135 may receive firmware update information and update files provided by network operators, and may transmit data to the Internet, content providers, or network operators.

The network interface 135 may select and receive a desired application from among applications open to the public through a network.

The storage 140 may store programs for processing and controlling each signal in the controller 170 and may store processed video, audio, or data signals. For example, the storage 140 may store application programs designed for the purpose of performing various tasks that may be processed by the controller 170 and selectively provide some of the stored application programs at the request of the controller 170.

Programs stored in the storage 140 are not particularly limited as long as they can be executed by the controller 170.

The storage 140 may execute a function of temporarily storing video, voice, or data signals received from an external device through the external device interface 130.

The storage 140 may store information on predetermined broadcast channel through a channel memory function such as a channel map.

Although FIG. 2 illustrates an embodiment in which the storage 140 is provided separately from the controller 170, the scope of the present disclosure is not limited thereto, and the storage 140 may be included in the controller 170.

The storage 140 may include at least one of a volatile memory (e.g., a DRAM, an SRAM, an SDRAM, etc.) or a non-volatile memory (e.g., a flash memory, a hard disk drive (HDD), a solid-state drive (SSD), etc.). In various embodiments of the present disclosure, “storage” and “memory” may be used interchangeably.

The user input interface 150 may transmit a signal input by a user to the controller 170 or transmit a signal from the controller 170 to the user.

For example, the user input interface 150 may transmit/receives user input signals such as power on/off, channel selection, and screen settings to/from the remote control device 200, transmit user input signals input through local keys (not shown) such as a power key, a channel key, a volume key, and a setting key to the controller 170, transmit a user input signal input through a sensor (not shown) that senses a user's gesture to the controller 170, or transmit signals from the controller 170 to the sensor.

The input part 160 may be provided on one side of the main body of the electronic device 100. For example, the input part 160 may include a touch pad, physical buttons, and the like.

The input part 160 may receive various user commands related to the operation of the electronic device 100 and transmit control signals related to the input commands to the controller 170.

The input part 160 may include at least one microphone (not shown) and may receive a user voice through the microphone.

The controller 170 may include at least one processor and may control the overall operation of the electronic device 100 using the processor included therein. Here, the processor may be a general processor such as a central processing unit (CPU). The processor may be a dedicated device such as an ASIC or another hardware-based processor.

The controller 170 may demultiplex streams input through the tuner 110, the demodulator 120, the external device interface 130, or the network interface 135, or process demultiplexed signals to generate and output signals for video or audio output.

The display 180 may convert a video signal, a data signal, an OSD signal, and a control signal processed by the controller 170 or a video signal, a data signal, and a control signal received from the external device interface 130 to generate driving signals.

The display 180 may include a display panel (not shown) having a plurality of pixels.

The plurality of pixels provided in the display panel may include RGB subpixels. Alternatively, the plurality of pixels provided in the display panel may include RGBW subpixels. The display 180 may convert a video signal, a data signal, an OSD signal, a control signal, etc. processed by the controller 170 to generate driving signals for the plurality of pixels.

The display 180 may be a plasma display panel (PDP), a liquid crystal display (LCD), an organic light emitting diode (OLED) display, or a flexible display, and may also be a 3D display. 3D displays 180 may be classified into a glasses-free type and a glasses type.

Meanwhile, the display 180 may be configured as a touch screen and used as an input device in addition to an output device.

The audio output part 185 receives the audio signal processed by the controller 170 and outputs the same as audio.

A video signal processed by the controller 170 may be input to the display 180 and displayed as an image related to the video signal. Additionally, the video signal processed by the controller 170 may be input to an external output device through the external device interface 130.

An audio signal processed by the controller 170 may be output as sound to the audio output part 185. Additionally, the audio signal processed by the controller 170 may be input to an external output device through the external device interface 130.

Although not illustrated in FIG. 2, the controller 170 may include a demultiplexer, an image processor, etc.

In addition, the controller 170 may control overall operations of the electronic device 100. For example, the controller 170 may control the tuner 110 to select (tune to) a broadcast related to a channel selected by the user or a previously stored channel.

Additionally, the controller 170 may control the electronic device 100 using a user command input through the user input interface 150 or an internal program.

Meanwhile, the controller 170 may control the display 180 to display an image. Here, the image displayed on the display 180 may be a still image or a video, and may be a 2D image or a 3D image.

Further, the controller 170 may cause a predetermined 2D object to be displayed in an image displayed on the display 180. For example, the object may be at least one of a connected web screen (newspaper, magazine, or the like), an electronic program guide (EPG), various menus, widgets, icons, a still image, a video, or text.

Meanwhile, the electronic device 100 may further include an imaging device (not shown). The imaging device may capture an image of the user. The imaging device may be implemented as a single camera, but the present disclosure is not limited thereto and the imaging device may also be implemented as a plurality of cameras. Meanwhile, the imaging device may be embedded in the electronic device 100 at the top of the display 180 or may be disposed separately. Image information captured by the imaging device may be input to the controller 170.

The controller 170 may recognize a location of the user based on images captured by the imaging device. For example, the controller 170 may ascertain the distance (z-axis coordinate) between the user and the electronic device 100. In addition, the controller 170 may ascertain the x-axis coordinate and y-axis coordinate in the display 180 related to the location of the user.

The controller 170 may detect a user's gesture based on images captured by the imaging device, each signal detected by a sensor, or a combination thereof.

The power supply 190 may supply corresponding power throughout the electronic device 100. In particular, the power supply 190 may supply power to the controller 170, which may be implemented in the form of a system on chip (SOC), the display 180 for displaying images, and the audio output part 185 for audio output.

Specifically, the power supply 190 may include a converter (not shown) that converts AC power to DC power and a DC/DC converter (not shown) that converts a DC power level.

The remote control device 200 may transmit user input to the user input interface 150. To this end, the remote control device 200 may use Bluetooth, radio frequency (RF) communication, infrared communication, ultra-wideband (UWB), ZigBee, and the like. Additionally, the remote control device 200 may receive video, audio, or data signals output from the user input interface 150 and display the same or output the same as audio through the remote control device 200.

The electronic device 100 described above may be a stationary or mobile digital broadcast receiver capable of receiving digital broadcasting.

Meanwhile, the block diagram of the electronic device 100 shown in FIG. 2 is merely a block diagram for an embodiment of the present disclosure, and components of the block diagram may be integrated, added, or omitted according to the specifications of the electronic device 100 that is actually implemented.

That is, two or more components may be combined into one component, or one component may be subdivided into two or more components as necessary. In addition, the function executed by each block is for describing an embodiment of the present disclosure, and the specific operation or device does not limit the scope of the present disclosure.

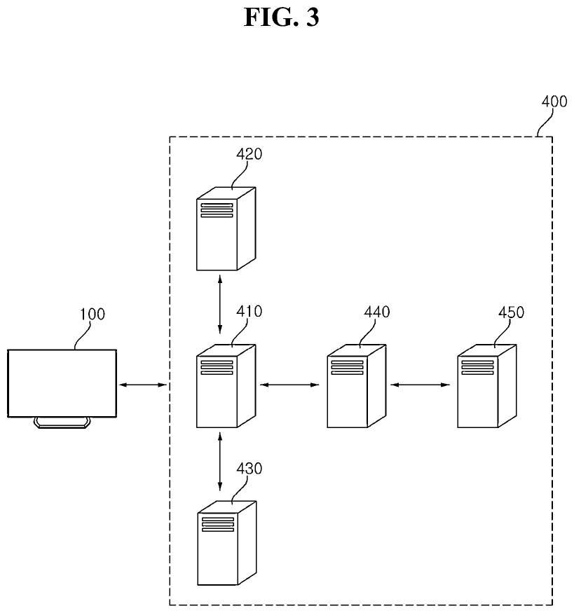

FIG. 3 is a diagram referenced in description of the server of FIG. 1.

Referring to FIG. 3, the server 400 may include a relay server 410, a speech-to-text (STT) server 420, a natural language processing (NLP) server 430, a user identification server 440, and/or an account server 450. Although the relay server 410, the STT server 420, the NLP server 430, the user identification server 440, and the account server 450 are distinguished from each other in the present disclosure, the present disclosure is not limited thereto. For example, two or more of the relay server 410, the STT server 420, the NLP server 430, the user identification server 440, and the account server 450 may be configured as one server.

The relay server 410 may communicate with the electronic device 100. The relay server 410 may transmit data between the STT server 420, the NLP server 430, the user identification server 440, and the electronic device 100. The relay server 410 may store at least some data transmitted between the STT server 420, the NLP server 430, the user identification server 440, and the electronic device 100.

The STT server 420 may receive audio data. The STT server 420 may convert the audio data into text data. The STT server 420 may transmit the text data to the electronic device 100 via the relay server 410. The STT server 420 may be called an automatic speech recognition (ASR) server.

The STT server 420 may increase the accuracy of speech-to-text conversion using a language model. A language model may refer to a model that may calculate the probability of a sentence or the probability of the next word appearing when previous words are provided. For example, the language model may include probabilistic language models such as Unigram model, Bigram model, and N-gram model. That is, the STT server 420 may determine whether text data has been appropriately converted from audio data, and accordingly, increase the accuracy of conversion to text data.

The NLP server 430 may receive text data. The NLP server 430 may perform intent analysis on the text data based on the received text data. The NLP server 430 may transmit intent analysis information indicating the result of intent analysis to the electronic device 100 via the relay server 410.

According to an embodiment, the NLP server 430 may generate intent analysis information by sequentially performing a morpheme analysis step, a syntax analysis step, a speech-act analysis step, a conversation processing step, and the like on text data. The morpheme analysis step is a step of classifying text data related to speech uttered by a user into morpheme units, which are the smallest units with meaning, and determining to what part of speech each classified morpheme corresponds. The syntax analysis step is a step of classifying text data into noun phrases, verb phrases, adjective phrases, and the like using the results of the morpheme analysis step and determining what kind of relationship is present between the classified phrases. Through the syntax analysis step, subjects, objects, and modifiers of speech uttered by a user may be determined. The speech-act analysis step is a step of analyzing the intention of speech uttered by a user using the results of the syntax analysis step. Specifically, the speech-act analysis step is a step of determining the intention of a sentence, such as whether a user is asking a question, making a request, or simply expressing an emotion. The conversation processing step is a step of determining whether to reply to user's utterance, respond thereto, or ask a question for additional information.

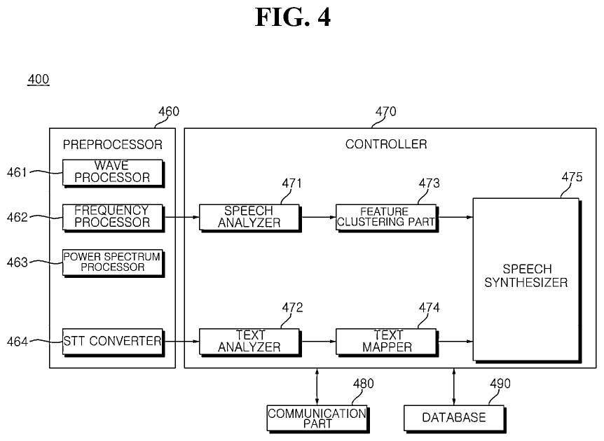

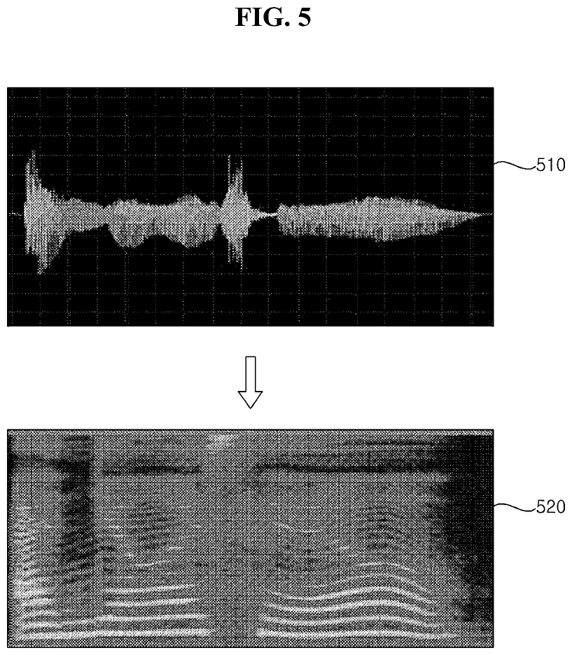

The user identification server 440 may receive audio data. The user identification server 440 may extract voice features based on the audio data. Here, the voice features may include the waveform of the voice, the frequency band of the voice, the power spectrum of the voice, and the like. Extraction of voice features will be described later with reference to FIG. 4 and FIG. 5.

The user identification server 440 may obtain a voice feature vector from the voice features. The user identification server 440 may obtain the voice feature vector from the voice features based on a linear predictive coefficient, cepstrum, Mel frequency cepstral coefficient (MFCC), and filter bank energy.

The user identification server 440 may determine a similarity between a plurality of feature vectors. The user identification server 440 may determine the similarity between the plurality of feature vectors using cosine similarity, Euclidean similarity, or the like. Although an example of calculating a similarity between a first voice input and a second voice input based on cosine similarity will be described in the present disclosure, the method of determining a similarity is not limited thereto. For example, a first vector related to first text and a second vector related to second text may be created. A cosine similarity between the first vector and the second vector may be calculated based on Formula 1 below.

$$cos ( Θ ) = \frac{A \cdot B}{‖ A ‖ ‖ B ‖} = \frac{{\sum }_{i = 1}^{n} {A}_{i} \times {B}_{i}}{\sqrt{{\sum }_{i = 1}^{n} {( {A}_{i} )}^{2}} \times \sqrt{{\sum }_{i = 1}^{n} {( {B}_{i} )}^{2}}} \qquad [ Formula 1 ]$$

Here, A·B indicates the dot product of two vectors, an ∥A∥ and ∥B∥ indicate the magnitudes of the two vectors. That is, cosine similarity may be calculated by dividing the dot product of two vectors by the product of the magnitudes of the vectors. Cosine similarity may range from −1 to 1, and two vectors are determined to be similar as the cosine similarity therebetween is closer to 1.

The user identification server 440 may determine whether users who have uttered speech are the same based on the similarity between a plurality of feature vectors. For example, when a similarity between a first feature vector related to the first voice input and a second feature vector related to the second voice input is equal to or greater than a predetermined standard, the user identification server 440 may determine that the user who has uttered the first voice input and the user who has uttered the second voice input are the same.

According to an embodiment, the user identification server 440 may obtain a vector by processing a voice feature vector using an algorithm such as the Gaussian mixture model (GMM), supervector, i-vector, d-vector, x-vector, or the like. The user identification server 440 may determine whether users who have uttered voices are the same based on a similarity between a first vector obtained by processing a first feature vector and a second vector obtained by processing a second feature vector.

The user identification server 440 may store audio data. The user identification server 440 may store data on voiceprint (hereinafter, voiceprint information). Here, voiceprint information may include a voice feature vector and/or a vector obtained by processing the voice feature vector.

The user identification server 440 may store a voice database. The voice database regarding voices may include unique identification information related to the electronic device 100 (hereinafter referred to as device identification information), unique identification information related to a user account (hereinafter referred to as user identification information), voice data mapped to user identification information, voiceprint information mapped to user identification information.

The device identification information, user identification information, audio data, and voiceprint information included in the voice database may be stored in the user identification server 440 in association with one another. For example, at least one piece of device identification information, a plurality of pieces of audio data, and/or a plurality of pieces of voiceprint information may be mapped to user identification information. That is, it may be interpreted that device identification information, audio data, and voiceprint information are mapped to a user account and stored in the user identification server 440. In the present disclosure, an example in which a plurality of pieces of audio data and a plurality of pieces of voiceprint information are all mapped to user identification information included in the voice database will be described.

The user identification server 440 may update voiceprint information included in a voice database based on audio data included in the voice database. For example, the user identification server 440 may generate voiceprint information related to audio data included in the voice database using an algorithm different from a previously used algorithm. Here, the user identification server 440 may change the voiceprint information included in the voice database to the newly generated voiceprint information.

The account server 450 may manage data regarding user accounts. The account server 450 may manage user account IDs, passwords, user identification information, device identification information mapped to user accounts, and whether or not users agree to terms and conditions related to various functions.

The account server 450 may store a database regarding user accounts. The database regarding user accounts may include user account IDs, passwords, user identification information, device identification information mapped to the user accounts, registration dates and times of the user accounts, whether or not users agree to terms and conditions related to various functions, and dates and times when users agree to the terms and conditions.

The account server 450 may communicate with the electronic device 100. For example, the account server 450 may create and register a user account based on data from the electronic device 100. For example, the account server 450 may approve login of a user account based on an ID and a password received from the electronic device 100.

FIG. 4 is a block diagram for describing the configuration of the server according to an embodiment of the present disclosure.

Referring to FIG. 4, the server 400 may include a preprocessor 460, a controller 470, a communication interface 480, and/or a database 490.

The preprocessor 460 may preprocess speech received through the communication interface 480 or speech stored in the database 490.

The preprocessor 460 may be implemented as a separate chip from the controller 470 or may be implemented as a chip included in the controller 470.

The preprocessor 460 may receive a voice signal (uttered by a user) and filter noise signals from the voice signal before converting the received voice signal into text data.

If the preprocessor 460 is provided in the electronic device 100, the preprocessor 460 may recognize a startup word for activating speech recognition of the electronic device 100. The preprocessor 460 may convert the startup word received through the user input interface 150 into text data, and if the converted text data is text data related to a pre-stored startup word, determine that the startup word is recognized.

The preprocessor 460 may convert the noise-removed voice signal into a power spectrum.

A power spectrum may be a parameter that indicates a frequency component included in a temporally varying waveform of a voice signal and the magnitude of the frequency component.

A power spectrum shows a distribution of squared amplitude values according to the frequency of the waveform of a voice signal. This will be described with reference to FIG. 5.

FIG. 5 is a diagram illustrating an example of converting a voice signal into a power spectrum according to an embodiment of the present disclosure.

FIG. 5 shows a voice signal 510. The voice signal 510 may be a signal received from an external device or may be a signal previously stored in the memory 170.

The x-axis of the voice signal 510 represents time, and the y-axis represents amplitude.

A power spectrum processor 463 may convert the voice signal 510 in which the x-axis is the time axis into a power spectrum 520 in which the x-axis is the frequency axis. The power spectrum processor 463 may convert the voice signal 510 into the power spectrum 520 using Fast Fourier transform (FFT). The x-axis of the power spectrum 520 represents frequency, and the y-axis represents the square of amplitude.

Referring back to FIG. 4, the functions of the preprocessor 460 and the controller 470 described in FIG. 4 may also be performed in the NLP server 430.

The preprocessor 460 may include a wave processor 461, a frequency processor 462, the power spectrum processor 463, a speech-to-text (STT) converter 464, and the like.

The wave processor 461 may extract the waveform of speech.

The frequency processor 462 may extract the frequency band of the speech.

The power spectrum processor 463 may extract the power spectrum of the speech.

A power spectrum may be a parameter that indicates, when a temporally varying waveform is given, a frequency component included in the waveform and the magnitude of the frequency component.

The STT converter 464 may convert speech into text.

The STT converter 464 may convert speech in a specific language into text in that language.

The controller 470 may control the overall operation of the server 400. The controller 470 may include a speech analyzer 471, a text analyzer 472, a feature clustering part 473, a text mapper 474, and/or a speech synthesizer 475.

The speech analyzer 471 may extract speech characteristic information using one or more of the waveform of speech, the frequency band of the speech, and the power spectrum of the speech preprocessed in the preprocessor 460. The speech characteristic information may include one or more of information on the sex of a speaker, the voice (or tone) of the speaker, the pitch of voice, the speaking style of the speaker, the speech rate of the speaker, and the emotion the speaker. Additionally, the speech characteristic information may further include the timbre of the speaker.

The text analyzer 472 may extract main expressions from text converted by the STT converter 464. Upon detecting a change in tone between phrases from the converted text, the text analyzer 472 may extract the phrase with a different tone as a main expression phrase. The text analyzer 472 may determine that the tone has changed when the frequency band between phrases has changed more than a preset band. The text analyzer 472 may extract key words from phrases in the converted text. A key word may be a noun present in a phrase, but this is merely an example.

The feature clustering part 473 may classify the speech type of the speaker using the speech characteristic information extracted by the speech analyzer 471. The feature clustering part 473 may classify the speech type of the speaker by assigning a weight to each type item constituting the speech characteristic information. The feature clustering part 473 may classify the speech type of the speaker using an attention technique of a deep learning model.

The text mapper 474 may translate text converted into a first language into text in a second language. The text mapper 474 may map the text translated into the second language with the text in the first language. The text mapper 474 may map main expressions constituting the text in the first language to corresponding phrases in the second language. The text mapper 474 may map a speech type related to the main expressions constituting the text in the first language to phrases in the second language. This is for the purpose of applying the classified speech type to the phrases in the second language.

The speech synthesizer 475 may apply the speech type and speaker's tone classified by the feature clustering part 473 to the main expressions of the text translated into the second language in the text mapper 474 to generate synthetic speech.

The controller 470 may determine the speech characteristics of the user using one or more of the transmitted text data or the power spectrum 520.

Speech characteristics of a user may include the sex, pitch, tone, speech topic, speech rate, and voice volume of the user.

The controller 470 may obtain the frequency of the voice signal 510 and the amplitude corresponding to the frequency.

The controller 470 may determine the sex of the user who has uttered the voice using the frequency band of the power spectrum 470. For example, if the frequency band of the power spectrum 520 is within a preset first frequency band range, the controller 470 may determine that the user is male.

If the frequency band of the power spectrum 520 is within a preset second frequency band range, the controller 470 may determine that the user is female. Here, the second frequency band range may be higher than the first frequency band range.

The controller 470 may determine the pitch of voice using the frequency band of the power spectrum 520. For example, the controller 470 may determine the pitch of the voice based on the amplitude within a specific frequency band.

The controller 470 may determine the user's tone using the frequency band of the power spectrum 520. For example, the controller 470 may determine a frequency band with an amplitude equal to or greater than a certain level among the frequency bands of the power spectrum 520 as a main sound range of the user and determine this main sound range as the user's tone.

The controller 470 may determine the user's speech rate based on the number of syllables uttered per unit time from the converted text data.

The controller 470 may determine the topic of the user's speech using the Bag-Of-Word Model technique for the converted text data.

The Bag-Of-Word Model technique is a technique of extracting frequently used words based on the frequency of a word in a sentence. Specifically, the Bag-Of-Word Model technique is a technique of extracting unique words within a sentence and expressing the frequency of each extracted word as a vector to determine the features of the topic of speech. For example, if words such as “running” and “physical strength” appear frequently in text data, the controller 470 may classify the topic of the user's speech as exercise.

The controller 470 may determine the topic of the user's speech from the t text data using a known text categorization technique. The controller 470 may extract keywords from the text data and determine the topic of the user's speech.

The controller 470 may determine the user's voice volume by considering amplitude information in the entire frequency band. For example, the controller 470 may determine the user's voice volume based on the average or weighted average of amplitudes in each frequency band of the power spectrum 470.

The communication interface 480 may communicate with an external server by wire or wirelessly. The communication interface 480 may communicate with the electronic device 100 by wire or wirelessly.

The database 490 may store speech in first language included in content. The database 490 may store synthetic speech in which speech in the first language has been converted into speech in the second language. The database 490 may store first text related to speech in the first language and second text in which the first text has been translated into the second language. The database 490 may store various learning required models for speech recognition.

Meanwhile, the controller 170 of the electronic device 100 illustrated in FIG. 2 may include the preprocessor 460 and the controller 470 illustrated in FIG. 4. That is, the controller 170 of the electronic device 100 may perform the functions of the preprocessor 460 and the controller 470.

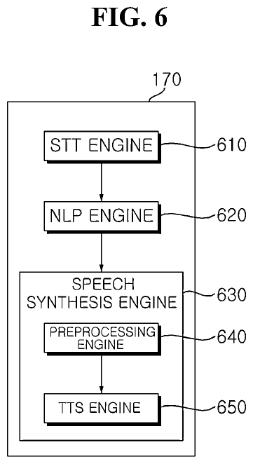

FIG. 6 is a block diagram illustrating a configuration of a controller for speech recognition and synthesis of an image display device according to an embodiment of the present disclosure.

That is, the speech recognition and synthesis process illustrated in FIG. 6 may be performed by the controller 170 of the electronic device 100 without using the server.

Referring to FIG. 6, the processor 170 of the electronic device 100 may include an STT engine 610, an NLP engine 620, and a speech synthesis engine 630. Each engine may be either hardware or software.

The STT engine 610 may perform the function of the STT server 420 of FIG. 5. That is, the STT engine 610 may convert audio data into text data.

The NLP engine 620 may perform the function of the NLP server 430 shown in FIG. 5. That is, the NLP engine 620 may obtain intent analysis information indicating the speaker's intention from the converted text data.

The speech synthesis engine 630 may perform a function of a speech synthesis server. The speech synthesis engine 630 may search a database for syllables or words related to given text data and synthesize a combination of the searched syllables or words to generate synthetic speech.

The speech synthesis engine 630 may include a preprocessing engine 631 and a TTS engine 632.

The preprocessing engine 631 may preprocess text data before generating synthetic speech. Specifically, the preprocessing engine 631 performs tokenization to divide text data into tokens, which are meaningful units. After performing tokenization, the preprocessing engine 631 may perform a cleansing operation to remove unnecessary characters and symbols to eliminate noise. Thereafter, the preprocessing engine 631 may generate the same word token by integrating word tokens with different expression methods. Thereafter, the preprocessing engine 631 may remove meaningless word tokens (stopwords).

The TTS engine 632 may synthesize speech related to the preprocessed text data and generate synthetic speech.

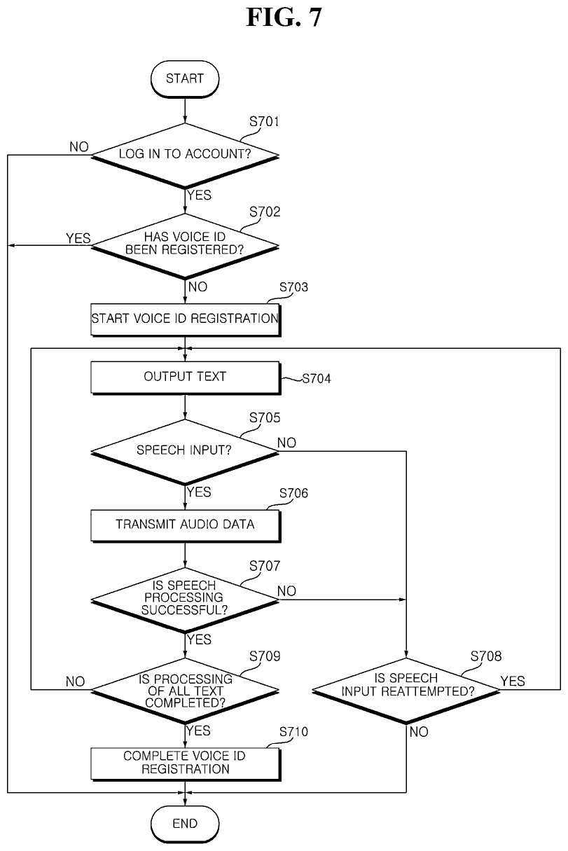

FIG. 7 is a flowchart of a method of operating an electronic device according to an embodiment of the present disclosure.

Referring to FIG. 7, the electronic device 100 may determine whether a user account is logged in to the server 400 in operation S701. For example, a user may log in to the server 400 with a user account by entering the user account ID and password.

According to an embodiment, when the user first logs in to the server 400 using the electronic device 100 with the user account, the electronic device 100 may include user identification information related to the user account in a user list. For example, in a case where three different user accounts log in to the server 400 using the electronic device 100, the user list stored in the electronic device 100 may include three different pieces of user identification information.

In operation S702, the electronic device 100 may determine whether voice-related identification information (hereinafter referred to as voice ID) is registered with respect to the user account logged in to the server 400. Here, the voice ID may include voiceprint information stored in the user identification server 440. For example, the server 400 may transmit information on whether a voice ID has been registered with respect to the user account logged in to the server 400 to the electronic device 100.

According to an embodiment, the server 400 may determine whether the voice ID has been registered based on whether voiceprint information has been mapped to user identification information, which is unique identification information related to the user account logged in to the server 400. Here, when the voice ID has not been registered with respect to the user account, the number of pieces of voiceprint information mapped to the user identification information may be 0.

According to an embodiment, the server 400 may determine that the voice ID has been registered if the number of pieces of voiceprint information mapped to the user identification information is two or more predetermined numbers and determine that the voice ID has not been registered if the number of pieces of voiceprint information is less than the predetermined numbers. For example, in the case of a user account for which a voice ID has been registered, six different pieces of voiceprint information may be mapped to user identification information. For example, in the case of a user account for which a voice ID has not been registered, five or fewer voiceprint information may be mapped to user identification information.

According to an embodiment, a flag value indicating whether a voice ID has been registered may be mapped to user identification information stored in the server 400. Here, user identification information to which a flag value is mapped may be stored in the user identification server 440 and/or the account server 450. The server 400 may determine whether the voice ID has been registered based on the flag value mapped to the user identification information. For example, a flag value mapped to user identification information may be 0 in the case of a user account for which a voice ID has not been registered, and a flag value mapped to user identification information may be 1 in the case of a user account for which a voice ID has been registered.

When the voice ID has not been registered with respect to the user account, the electronic device 100 may start a process of registering the voice ID in operation S703. For example, when starting the process of registering the voice ID, the electronic device 100 may transmit data containing the device identification information, the user identification information, a value indicating the start of registration of the voice ID, etc. to the server 400.

The electronic device 100 may output preset text in operation S704. The electronic device 100 may output any one of a plurality of pieces of preset text. For example, when the electronic device 100 is the image display device 100a, the electronic device 100 may output preset text through the display 180.

According to an embodiment, the server 400 may transmit any one of a plurality of pieces of preset text to the electronic device 100 in a preset order. Here, the electronic device 100 may output the preset text received from the server 400.

The electronic device 100 may determine whether speech with respect to the preset text is input in operation S705. For example, the electronic device 100 may determine whether speech is input through a microphone included in the input part 160 within a preset time. Here, the voice signal related to the speech input through the microphone may be transmitted to the controller 170 through the user input interface 150. For example, the electronic device 100 may determine whether data containing a voice signal related to speech uttered by the user is received from the remote control device 200 within a preset time.

When speech with respect to the preset text is input, the electronic device 100 may transmit audio data including the voice signal related to the speech to the server 400 in operation S706. Here, the electronic device 100 may transmit the device identification information, the user identification information, and a language code indicating the type of language to the server 400 along with the audio data.

The server 400 may convert the voice signal included in the audio data received from the electronic device 100 into text. The server 400 may determine whether the text converted from the voice signal and the preset text correspond to each other. For example, the server 400 may determine whether the text converted from the voice signal and the preset text correspond to each other based on the similarity therebetween.

The server 400 may generate voiceprint information related to the voice signal when the text converted from the voice signal and the preset text correspond to each other. The server 400 may map the voiceprint information generated with respect to the preset text to the user identification information and store the same. The server 400 may map the audio data received with respect to the preset text to the user identification information and store the same.

The electronic device 100 may determine whether speech processing for the preset text is successful based on the response received from the server 400 in operation S707. For example, if the text converted from the voice signal and the preset text correspond to each other, the server 400 may notify the electronic device 100 of success of speech processing. For example, when the voiceprint information related to the voice signal has been generated, the server 400 may notify the electronic device 100 of success of speech processing.

Meanwhile, in operation S708, the electronic device 100 may determine whether the user reattempts to input speech when speech with respect to the preset text is not input or when speech processing for the preset text fails. For example, the electronic device 100 may reattempt to input speech based on a user input from the user reattempting to input speech. Here, the electronic device 100 may output the preset text again.

In operation S709, if speech processing for the preset text is successful, the electronic device 100 may determine whether processing for all pieces of text is completed. For example, if all speech processing for six pieces of text is successful, processing for all pieces of text may be completed. Meanwhile, when processing for five pieces of preset text is completed, the electronic device 100 may output the last preset text.

The electronic device 100 may end the process of registering the voice ID when processing for all pieces of text is completed in operation S710. For example, when the electronic device 100 is the image display device 100a, the electronic device 100 may output a screen indicating completion of voice ID registration through the display 180. For example, the electronic device 100 may transmit data indicating completion of voice ID registration to the account server 450.

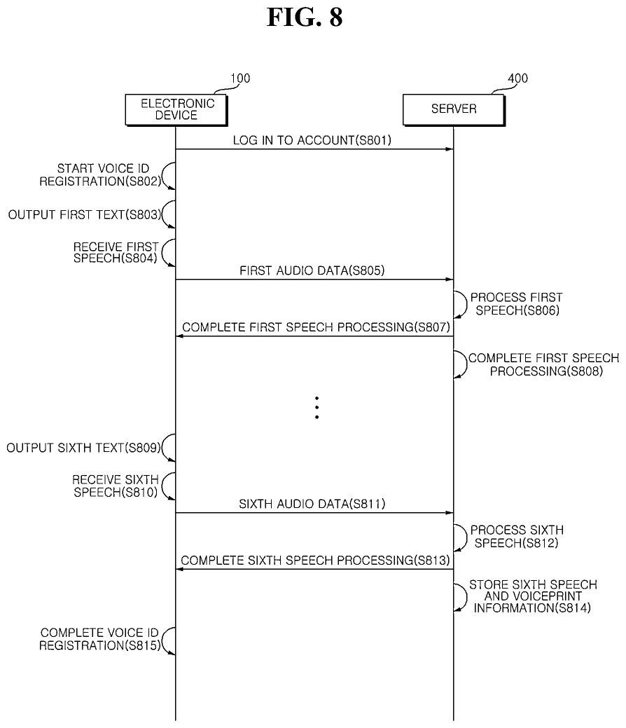

FIG. 8 is a flowchart of a method of operating a system according to an embodiment of the present disclosure.

Referring to FIG. 8, the electronic device 100 may log in to the server 400 using a user account in operation S801.

The electronic device 100 may start a process of registering a voice ID in operation S802.

The electronic device 100 may output first text among a plurality of pieces of preset text in operation S803.

The electronic device 100 may receive first speech for the first text in operation S804.

The electronic device 100 may transmit first audio data including a speech signal related to the first speech to the server 400 in operation S805.

The server 400 may process the first speech for the first text based on the first audio data received from the electronic device 100 in operation S806. The server 400 may convert the speech signal related to the first speech included in the first audio data received from the electronic device 100 into text. The server 400 may determine whether the text converted from the speech signal related to the first speech and the first text correspond to each other.

The server 400 may notify the electronic device 100 of completion of processing for the first speech in operation S807. For example, the server 400 may notify the electronic device 100 of success of processing for the first speech based on the fact that the text converted from the speech signal related to the first speech corresponds to the first text.

Further, the server 400 may generate first voiceprint information with respect to the first speech based on the speech signal related to the first speech based on the fact that the text converted from the speech signal related to the first speech corresponds to the first text.

The server 400 may store the first audio data and the first voiceprint information with respect to the first speech in operation S808. The server 400 may map the first audio data and first voiceprint information to the user identification information related to the logged-in user account and store the same.

The electronic device 100 may output the second to fifth pieces of text in stages. The electronic device 100 may sequentially receive second to fifth speeches related to the second to fifth pieces of text. The electronic device 100 may sequentially transmit second to fifth pieces of audio data related to the second to fifth speeches to the server 400.

The server 400 may process the second to fifth speeches based on the second to fifth pieces of audio data received from the electronic device 100. Additionally, the server 400 may sequentially generate and store second to fifth pieces of speech information related to the second to fifth speeches.

The electronic device 100 may output sixth text from among a plurality of pieces of preset text in operation S809.

The electronic device 100 may receive sixth speech with respect to the sixth text in operation S810.

The electronic device 100 may transmit sixth audio data including a speech signal related to the sixth speech to the server 400 in operation S811.

The server 400 may process the sixth speech with respect to the sixth text based on the sixth audio data received from the electronic device 100 in operation S812. The server 400 may convert a speech signal related to the sixth speech included in the sixth audio data received from the electronic device 100 into text. The server 400 may determine whether the text converted from the speech signal related to the sixth speech and the sixth text correspond to each other.

The server 400 may notify the electronic device 100 of completion of processing for the sixth speech in operation S813.

Meanwhile, when the text converted from the speech signal related to the sixth speech and the sixth text correspond to each other, the server 400 may generate sixth voiceprint information regarding the sixth speech based on the speech signal related to the sixth speech.

The server 400 may store the sixth audio data and the sixth voiceprint information regarding the sixth speech in operation S814. The server 400 may map the sixth audio data and the sixth voiceprint information to the user identification information related to the logged-in user account and store the same. Here, six different pieces of audio data and a plurality of pieces of voiceprint information may be mapped to the user identification information related to the logged-in user account.

The electronic device 100 may end the process of registering the voice ID in operation S815. For example, the electronic device 100 may end the process of registering the voice ID based on completion of processing for the six different pieces of preset text.

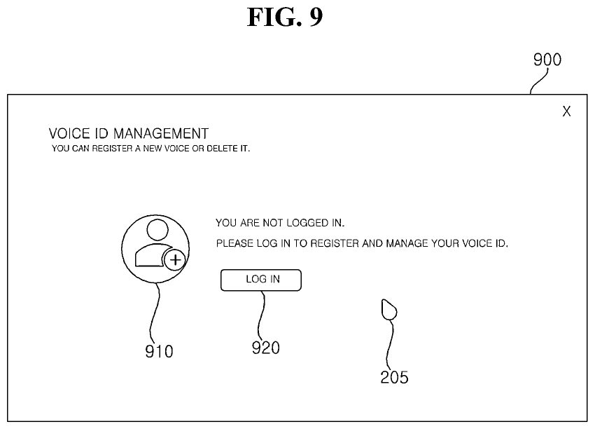

Referring to FIG. 9, if the user account is not logged in to the server 400, the electronic device 100 may output a login screen 900 related to logging in to the server 400 through the display 180. The login screen 900 may include an object 910 indicating a non-login state, and a login object 920 for executing login. When the user selects the login object 920 using a pointer 205 related to the remote control device 200, the electronic device 100 may output a screen for entering an ID and a password. Here, the user may log in to the server 400 with the user account by entering the ID and the password of the user account.

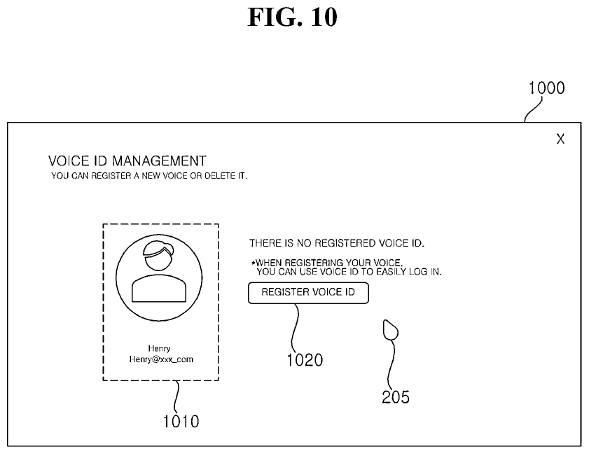

Referring to FIG. 10, when the voice ID has not been registered in the user account logged in to the server 400, the electronic device 100 may output a first account screen 1000 related to the user account for which the voice ID has not been registered. The first account screen 1000 may include an object 1010 indicating a logged-in user account, and an object 1020 regarding voice ID registration. When the user selects the object 1020 regarding voice ID registration using the pointer 205, the electronic device 100 may start the process of registering a voice ID.

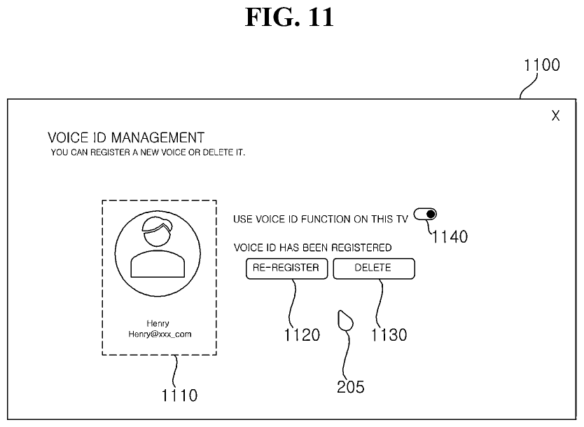

Referring to FIG. 11, when a voice ID has been registered in a user account logged in to the server 400, the electronic device 100 may display a second account screen 1100 related to the user account for which the voice ID has been registered. The second account screen 1100 may include an object 1110 indicating a logged-in user account, a re-registration object 1120 regarding voice ID re-registration, a deletion object 1130 regarding voice ID deletion, and an activation object 1140 regarding the use of a function related to voice ID. The user may select the activation object 1140 using the pointer 205 to activate or deactivate the use of a function related to voice ID.

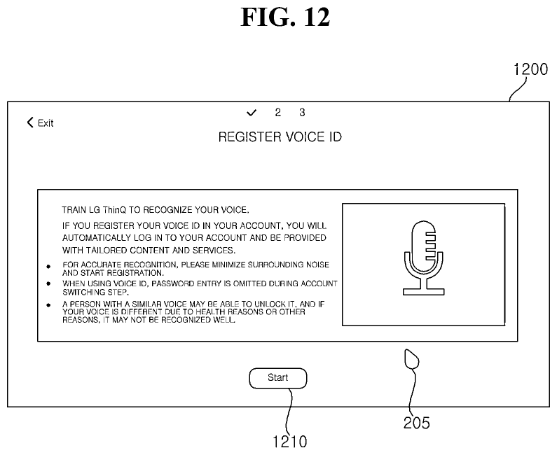

Referring to FIG. 12, when the object 1020 regarding voice ID registration is selected on the first account screen 1000, or when the re-registration object 1120 is selected on the second account screen 1100, the electronic device 100 may output a start screen 1200 for starting voice ID registration. When the user selects a start object 1210 using the pointer 205, the electronic device 100 may output a text screen for displaying preset text.

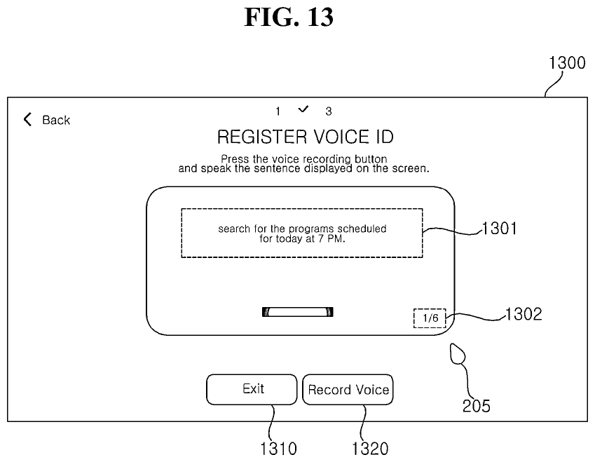

Referring to FIG. 13, the electronic device 100 may output a text screen 1300 for displaying any one of a plurality of pieces of preset text. The text screen 1300 may include preset text 1301, a text sequence number 1302, an end object 1310 for ending the process of registering a voice ID, and an input object 1320 for receiving speech.

When the user selects the end object 1310 using the pointer 205, the process of registering a voice ID may end. For example, when the process of registering a voice ID ends, all data stored in the server 400 while the process of registering a voice ID is in progress may be deleted.

When the user selects the input object 1320 using the pointer 205, the electronic device 100 may receive speech with respect to text.

According to an embodiment, when the user presses a predetermined button (e.g., a voice input button) included in the remote control device 200 while the text screen 1300 is displayed, the electronic device 100 may receive speech with respect to text based on the user input of pressing the predetermined button, received from the remote control device 200.

Meanwhile, according to an embodiment, when the user presses a predetermined button (e.g., the voice input button) included in the remote control device 200 while the process of registering a voice ID is in progress, the electronic device 100 may stop the process of registering a voice ID based on the user input of pressing the predetermined button, received from the remote control device 200. Here, the user input of pressing a predetermined button (e.g., the voice input button) included in the remote control device 200 may correspond to a user input of starting speech recognition for speech received through the remote control device 200. The electronic device 100 may perform an operation related to speech recognition on audio data including a speech signal received from the remote control device 200.

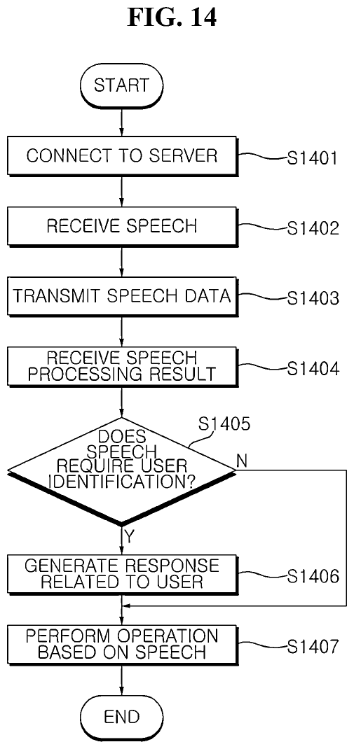

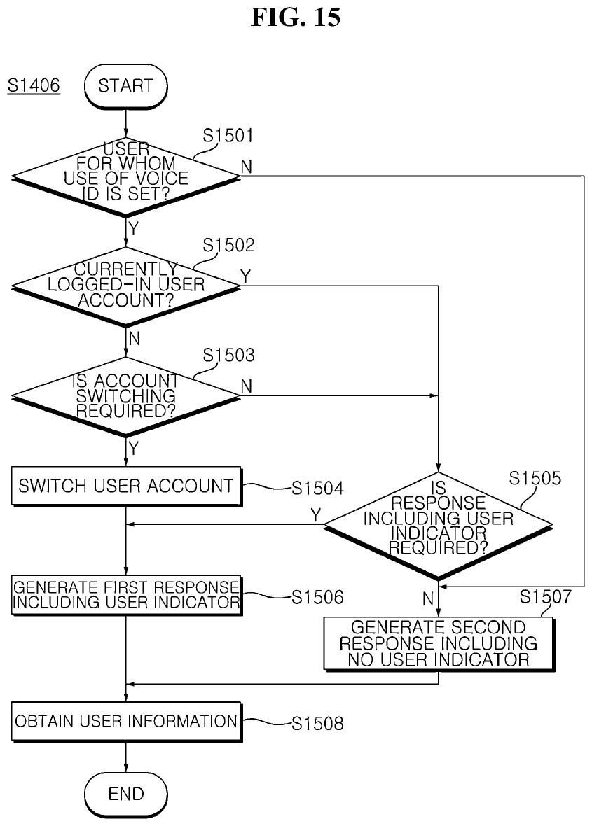

FIG. 14 and FIG. 15 are flowcharts of a method of operating the electronic device according to an embodiment of the present disclosure.

Referring to FIG. 14, the electronic device 100 may connect to the server 400 through the network interface 145 in operation S1401.

The electronic device 100 may receive speech in operation S1402. For example, the electronic device 100 may receive speech through a microphone included in the input part 160. Here, the speech signal related to the speech input through the microphone may be transmitted to the controller 170 through the user input interface 150. For example, the electronic device 100 may receive data containing a speech signal related to speech uttered by the user from the remote control device 200.

When speech is input in operation S1403, the electronic device 100 may transmit audio data related to the input speech to the server 400. Here, the electronic device 100 may transmit the device identification information, a user list, and a language code indicating a type of language to the server 400 along with the audio data.

The electronic device 100 may receive the result of speech processing from the server 400 in operation S1404. For example, the result of speech processing may include text related to the speech, intent analysis information that is the result of performing natural language processing on the speech, and user identification information related to the speech.

The server 400 may generate voiceprint information with respect to the speech input to the electronic device 100 based on the audio data received from the electronic device 100. The server 400 may search a database with respect to speech for voiceprint information (hereinafter referred to as candidate voiceprint information) related to user identification information included in the user list received from the electronic device 100. The server 400 may determine whether the candidate voiceprint information and the generated voiceprint information correspond to each other. The server 400 may determine user identification information to which candidate voiceprint information related to the generated voiceprint information is mapped among candidate voiceprint information as the user identification information related to the speech input to the electronic device 100. If there is no candidate voiceprint information related to the generated voiceprint information, the server 400 may determine that user identification information related to the speech input to the electronic device 100 is not present.

The server 400 may transmit the result of processing the audio data received from the electronic device 100 to the electronic device 100. For example, the server 400 may transmit, to the electronic device 100, text converted from the audio data received from the electronic device 100, intent analysis information representing the result of intent analysis performed on the converted text, user identification information related to the speech, and presence or absence of user identification information related to the speech.

In operation S1405, the electronic device 100 may determine whether the input speech requires user identification based on the result of speech processing.

According to an embodiment, the electronic device 100 may determine whether the input speech requires user identification based on the type of command related to the speech. For example, the electronic device 100 may determine that the input speech requires user identification based on the input speech related to a command related to the user account (e.g., user account login, user account switching, or the like). For example, the electronic device 100 may determine that the input speech requires user identification based on the input speech related to a command (e.g., content search, content recommendation, speech recommendation, external device connection, or the like) using user information such as a usage history, a viewing history, and preferred genres. For example, the electronic device 100 may determine that the input speech does not require user identification based on the input speech related to a command for checking general information (e.g., time, weather, etc.) unrelated to the user. For example, the electronic device 100 may determine that the input speech does not require user identification based on the input speech related to a command for adjusting settings (e.g., volume, screen brightness, etc.) of the electronic device 100.

According to an embodiment, the electronic device 100 may determine whether the input speech requires user identification based on the type of application related to the speech. For example, the electronic device 100 may determine that the input speech requires user identification based on the input speech related to an application (e.g., an over-the-top media service (OTT service), a social network service (SNS), or the like) linked to the user account. For example, the electronic device 100 may determine that the input speech does not require user identification based on the input speech related to an application (e.g., terrestrial broadcasting, weather, or the like) that is not linked to the user account.

In operation S1406, the electronic device 100 may generate a response related to the user when the input speech requires user identification. For example, when the input speech requires user identification, the electronic device 100 may generate a response including an indicator (hereinafter referred to as a user indicator) indicating the user who has uttered the speech based on user identification information related to the speech included in the speech processing result. Additionally, the electronic device 100 may output a response including a user indicator. Here, the user indicator may include the user's name, nickname, an icon, a photo, and the like related to the user identification information. The user indicator may be stored in the electronic device 100 and/or the server 400.

According to an embodiment, when the input speech requires user identification, the electronic device 100 may determine whether to generate a first response including a user indicator or a second response that does not include a user indicator. This will be described with reference to FIG. 15.

Referring to FIG. 15, the electronic device 100 may determine whether the user who has uttered speech is a user preset to use a voice ID based on user identification information related to the speech in operation S1501. For example, the electronic device 100 may store information on whether use of a voice ID-related function is activated for each piece of user identification information included in the user list. Here, if the use of the voice ID-related function is activated for the user identification information related to the speech included in the speech processing result, the electronic device 100 may determine that the user who has uttered the speech is a user preset to use the voice ID.

If there is no user identification information related to the speech based on the speech processing result, the electronic device 100 may determine that the user who has uttered the speech is not a user preset to use the voice ID.

If the user who has uttered the speech is a user preset to use the voice ID, the electronic device 100 may determine whether the user who has uttered the speech corresponds to the currently logged-in user account in operation S1502. For example, if the user identification information related to the speech corresponds to the user identification information related to the currently logged-in user account, the electronic device 100 may determine that the user who has uttered the speech corresponds to the currently logged-in user account.

If the user who has uttered the speech does not correspond to the currently logged-in user account, the electronic device 100 may determine whether switching of the user account is necessary in operation S1503. The electronic device 100 may determine whether switching of the user account is necessary based on intent analysis information included in the speech processing result. If there is no user account currently logged in to the server 400, the electronic device 100 may determine that switching of the user account is necessary.

According to an embodiment, the electronic device 100 may determine whether switching of the user account is necessary based on the type of command related to the speech. For example, the electronic device 100 may determine that switching of the user account is necessary based on the input speech related to a command related to the user account (e.g., login, user account switching, or the like). For example, the electronic device 100 may determine that user account switching is necessary based on the input speech related to a command for executing an application (e.g., OTT service, SNS, or the like) linked to the user account. For example, the electronic device 100 may determine that user account switching is necessary based on the input speech related to a command (e.g., content search, content recommendation, speech recommendation, external device connection, or the like) using information on the user such as a usage history, a viewing history, and preferred genres.

In operation S1504, the electronic device 100 may switch the user account logged in to the server 400 when it is necessary to switch the currently logged-in user account. For example, the electronic device 100 may log out the currently logged-in first user account. Upon completion of logging out of the first user account, the electronic device 100 may log in to the server 400 with a second user account related to the user identification information related to the speech. The electronic device 100 may switch the user account after completion of generation and output of the first response.

The electronic device 100 may determine whether generation of the first response including a user indicator is necessary when the user who has uttered the speech corresponds to the currently logged-in user account or when switching of the user account is unnecessary in operation S1505. For example, the electronic device 100 may determine that generation of the first response is necessary when the input speech requires information on the user who has uttered the speech based on the intent analysis information included in the speech processing result.

The electronic device 100 may generate the first response including a user indicator in operation S1506. For example, the electronic device 100 may generate text (hereinafter referred to as response text) in response to the input speech based on the intent analysis information included in the speech processing result. Here, the electronic device 100 may generate text including both the response text and the user name as the first response.

The electronic device 100 may generate a second response that does not include a user indicator in operation S1507.

The electronic device 100 may obtain information on the user in operation S1508. For example, the electronic device 100 may obtain a usage history stored in the storage 140 in relation to the user of the currently logged-in user account. For example, the electronic device 100 may obtain the name, nickname, icon, photo, age, sex, preferred genre, and the like stored in the server 400 in relation to the currently logged-in user account.

According to an embodiment, the electronic device 100 may generate the first response or the second response after obtaining information on the user.

Referring back to FIG. 14, the electronic device 100 may perform an operation according to the speech in operation S1407. For example, when the input speech requires user identification, the electronic device 100 may output either the first response or the second response. For example, the electronic device 100 may output the second response when the input speech does not require user identification.

Meanwhile, the electronic device 100 may perform an operation according to a command related to the input speech based on intent analysis information included in speech processing results.

According to an embodiment, when logging in to the server 400 with a user account, the electronic device 100 may obtain setting values related to the user account logging in to the server 400. Here, the setting values related to the user account may be stored in the storage 140 and/or the server 400 of the electronic device 100. For example, the electronic device 100 may obtain image quality setting values, sound quality setting values, mode setting values, and application setting values stored in the storage 140 and/or the server 400 in relation to the user of the currently logged-in user account.

Meanwhile, the setting values related to the user account stored in the server 400 may be stored separately for each piece of device identification information mapped to the user account. Here, the electronic device 100 may transmit device identification information related to the electronic device 100 to the server 400 to obtain setting values related to the user account.

For example, in a case where a plurality of pieces of device identification information is mapped to user identification information related to the user account stored in the server 400, image quality setting values mapped to first device identification information related to a first image display device may be different from image quality setting values mapped to second device identification information related to a second image display device.

For example, in a case where a plurality of pieces of device identification information is mapped to the user identification information related to the user account stored in the server 400, application setting values mapped to the first device identification information related to the first image display device may be different from application setting values mapped to the second device identification information related to the second image display device. Here, the application setting values mapped to the plurality of pieces of device identification information may be set depending on degrees to which an application is used in electronic devices 100 related to the plurality of pieces of device identification information. Meanwhile, the application setting values mapped to the plurality of pieces of device identification information may be set by the user.

The electronic device 100 may update preset setting values for the electronic device 100 based on the setting values related to the user account. For example, the electronic device 100 may update image quality setting values and sound quality setting values that are preset for the electronic device 100 based on the image quality setting values and the sound quality setting values related to the user account. For example, if a mode setting value related to the user account is a kids mode, the electronic device 100 may update a preset mode for the electronic device 100 to the kids mode. Here, the kids mode may refer to a mode in which age-related restrictions are set in relation to operations of the electronic device 100, such as providing content and executing applications. For example, the electronic device 100 may block execution of a specific application when the kids mode is set and execute the specific application when the kids mode is cancelled.

According to an embodiment, when logging in to the server 400 with a user account, the electronic device 100 may obtain a notification related to the user account logging in to the server 400. The notification related to the user account may be stored in the storage 140 and/or the server 400 of the electronic device 100. For example, the electronic device 100 may obtain a schedule, reservation for viewing, etc. stored in the storage 140 and/or the server 400 in relation to the user of the currently logged-in user account.

According to an embodiment, when logging in to the server 400 with a user account according to speech uttered by a user, the electronic device 100 may provide a user interface (hereinafter referred to as an audio UI) related to the speech. For example, the audio UI may include numbers mapped to objects included in the screen.

Meanwhile, when logging in to the server 400 with a user account according to an input different from speech, the electronic device 100 may provide a user interface (hereinafter referred to as a general UI) different from the audio UI. For example, when a user enters a user account ID and a password through the remote control device 200 and logs in to the server 400 with a user account, the electronic device 100 may provide the general UI.

According to an embodiment, the electronic device 100 may provide the audio UI when executing an application or a function according to speech uttered by a user. Meanwhile, the electronic device 100 may provide the general UI when executing an application or a function according to an input different from speech.

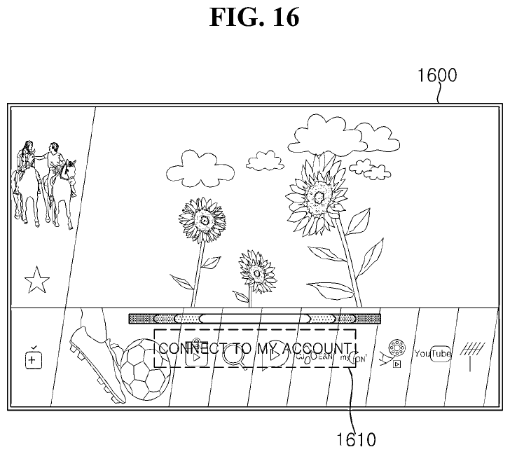

Referring to FIG. 16, the electronic device 100 may output a first home screen 1600. The first home screen 1600 may be displayed while logged in to the server 400 with a first user account.

Upon receiving speech uttered by a user, the electronic device 100 may output text 1610 related to the speech uttered by the user based on the result of processing the speech received from the server 400. The electronic device 100 may determine that the speech uttered by the user corresponds to a command related to the user account based on the speech processing result received from the server 400.

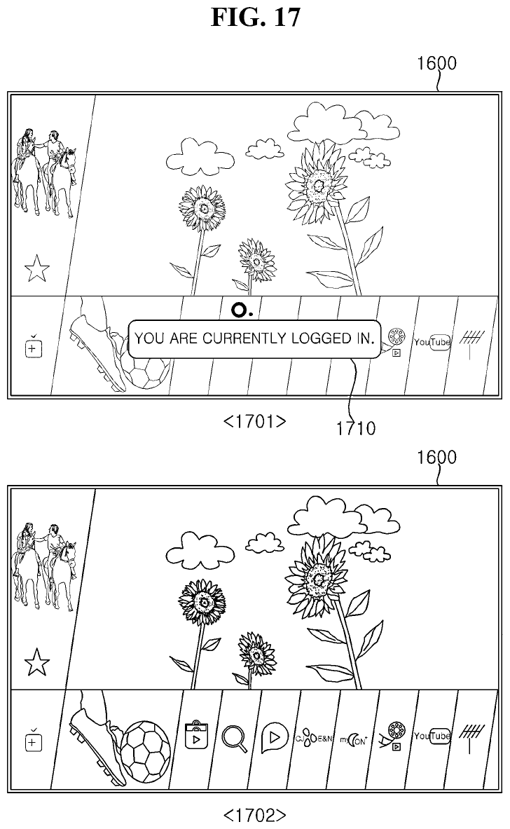

Referring to reference numeral 1701 in FIG. 17, a voice ID may be registered in the user account of the user who has uttered the speech, and use of the voice ID-related function may be activated. Additionally, the user who has uttered the speech may correspond to the currently logged-in first user account. In this case, the electronic device 100 may output a second response 1710 that does not include a user indicator and indicates that the user account of the user who has uttered the speech is currently logged in.

Referring to reference numeral 1702 in FIG. 17, when the user who has uttered the speech corresponds to the currently logged-in first user account, the electronic device 100 may output the first home screen 1600 without logging in to the server 400 with the user account or user account switching. The brightness of the first home screen 1600 may be set depending on image quality setting values related to the first user account. Here, the brightness among the image quality setting values related to the first user account may be a first brightness value.

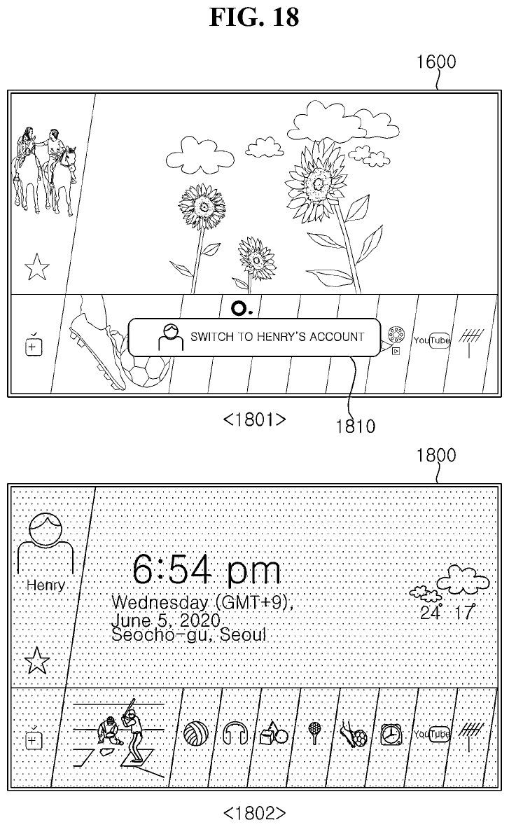

Referring to reference numeral 1801 in FIG. 18, a voice ID may be registered in the user account of the user who has uttered the speech, and use of the voice ID-related function may be activated. Additionally, the user who has uttered the speech may not correspond to the currently logged-in first user account. In this case, the electronic device 100 may output a first response 1810 that includes a user indicator and indicates that login is performed with the user account of the user who has uttered the speech.

The electronic device 100 may switch the user account logged in to the server 400 from the currently logged-in first user account to a second user account of the user who has uttered the speech. For example, the electronic device 100 may log out of the currently logged-in first user account and then log in to the server 400 using the second user account of the user who has uttered the speech. According to an embodiment, while switching user accounts, the electronic device 100 may output a user switching screen related to user switching. For example, the user switching screen may include an object representing the first user account, an object representing the second user account, an object representing user account switching, etc.

When logging in to the server 400 with the second user account, the electronic device 100 may obtain setting values related to the second user account. For example, the electronic device 100 may obtain image quality setting values related to the second user account from the storage 140 and/or the server 400.

Referring to reference numeral 1802 in FIG. 18, the electronic device 100 may output a second home screen 1800 related to the second user account while being logged in with the second user account. The second home screen 1800 may be different from the first home screen 1600. That is, the style of a home screen output from the electronic device 100, for example, the types, number, and arrangement of objects included in the home screen, may be different for each user account.

The brightness of the second home screen 1800 may be set depending on image quality setting values related to the second user account. Here, the brightness among the image quality setting values related to the second user account may be a second brightness value that is lower than the first brightness value. Accordingly, the second home screen 1800 may be displayed relatively dark compared to the first home screen 1600.

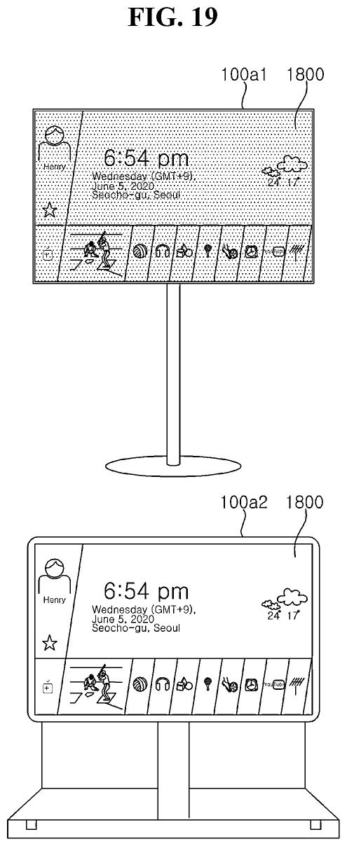

Referring to reference numeral 1901 in FIG. 19, a first electronic device 100a1 may output the second home screen 1800 related to the second user account while being logged in with the second user account.

When logging in to the server 400 with the second user account, the first electronic device 100a1 may obtain setting values related to the second user account. For example, the first electronic device 100a1 may obtain image quality setting values related to the second user account from the server 400. Here, the first electronic device 100a1 may obtain image quality setting values mapped to device identification information related to the first electronic device 100a1 among a plurality of pieces of device identification information mapped to user identification information related to the second user account stored in the server 400.

The brightness of the second home screen 1800 displayed through the first electronic device 100a1 may be set depending on the image quality setting values mapped to the device identification information related to the first electronic device 100a1. Here, the brightness among the image quality setting values mapped to the device identification information related to the first electronic device 100a1 may be a third brightness value.

Referring to reference numeral 1902 in FIG. 19, a second electronic device 100a2 may output the second home screen 1800 related to the second user account while being logged in with the second user account.

When logging in to the server 400 with the second user account, the second electronic device 100a2 may obtain setting values related to the second user account. For example, the second electronic device 100a2 may obtain image quality setting values related to the second user account from the server 400. Here, the second electronic device 100a2 may obtain image setting values mapped to the device identification information related to the second electronic device 100a2 among a plurality of pieces of device identification information mapped to the user identification information related to the second user account stored in the server 400.

The brightness of the second home screen 1800 output through the second electronic device 100a2 may be set depending on the image quality setting values mapped to the device identification information related to the second electronic device 100a2. Here, the brightness among the image quality setting values mapped to the device identification information related to the second electronic device 100a2 may be a fourth brightness value that is higher than the third brightness value. Accordingly, the second home screen 1800 output through the second electronic device 100a2 may be displayed relatively brightly compared to the second home screen 1800 output through the first electronic device 100a1.

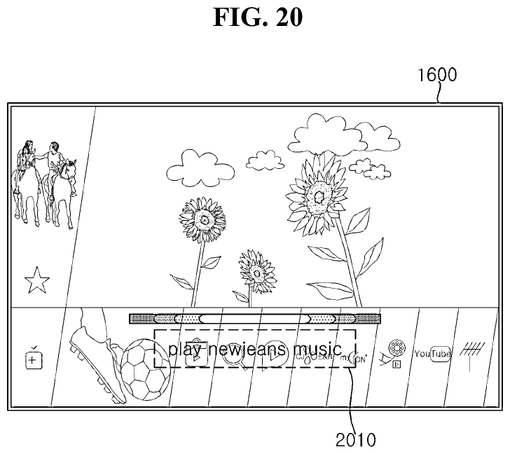

Referring to FIG. 20, the electronic device 100 may output the first home screen 1600. Upon receiving speech uttered by a user, the electronic device 100 may output text 2010 related to the speech uttered by the user based on the result of processing the speech received from the server 400. The electronic device 100 may determine that the speech uttered by the user is related to a command for searching for music content. Here, the command for searching for content may be a command that uses information on the user.

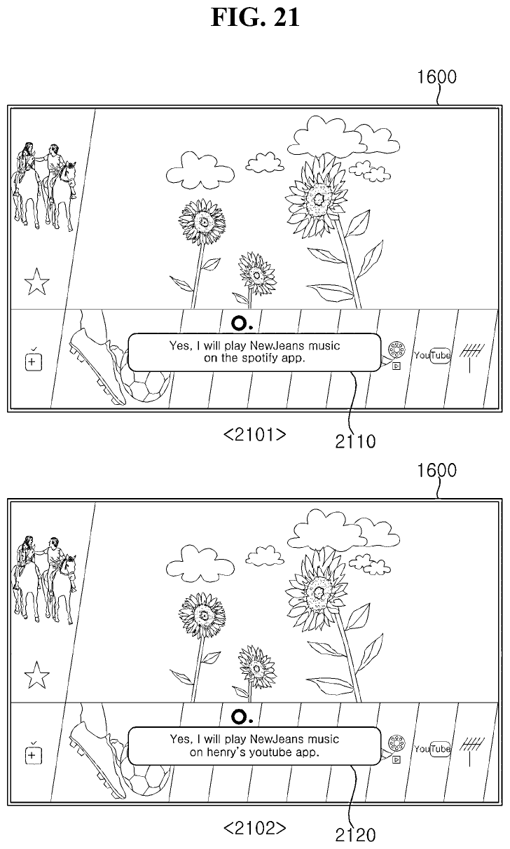

Referring to reference numeral 2101 in FIG. 21, the electronic device 100 may output a second response 2110 that does not include a user indicator and indicates music content search. For example, when no voice ID has been registered in a user account of a user who has uttered speech, the user who has uttered the speech is not a user preset to use a voice ID, or the user who has uttered the speech is related to the currently logged-in first user account, the electronic device 100 may output a second response 2110 that does not include a user indicator.

The electronic device 100 may obtain information on the user of the first user account and/or setting values related to the first user account from the storage 140 and/or the server 400. The electronic device 100 may determine an application related to music content related to the user of the first user account based on the information on the user and/or the setting values acquired in relation to the first user account. For example, if a history of using a first content application in relation to music content is stored in the storage unit 140 of the electronic device 100 in relation to the user of the first user account, the electronic device 100 may determine that the first content application is executed. For example, when the first content application is preset in the server 400 with application setting values related to music content in relation to the user of the first user account, the electronic device 100 may determine that the first content application is executed.

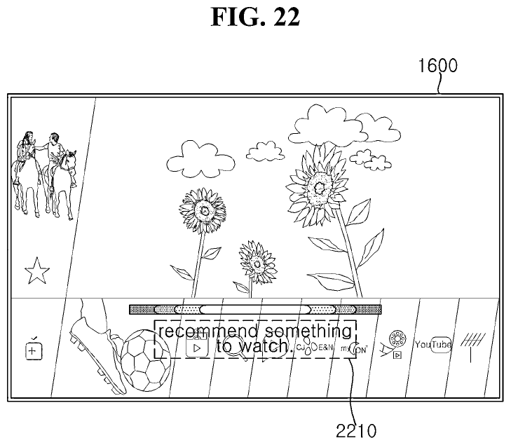

Referring to reference numeral 2102 in FIG. 22, if the second user account is different from the currently logged-in first user account in a state in which use of a voice ID-related function is activated for the second user account of the user who has uttered speech, the electronic device 100 may switch the user account logged in to the server 400 from the currently logged-in first user account to the second user account of the user who has uttered the speech. Additionally, the electronic device 100 may output a first response 2120 that includes a user indicator and notifies of music content search.

The electronic device 100 may obtain information on the user of the second user account and/or setting values related to the second user account from the storage 140 and/or the server 400. The electronic device 100 may determine an application related to music content related to the user of the second user account based on the information on the user and/or the setting values obtained in relation to the second user account. For example, if a history of using a second content application in relation to music content is stored in the storage unit 140 of the electronic device 100 in relation to the user of the second user account, the electronic device 100 may determine that the second content application is executed. For example, when the second content application is preset in the server 400 with application setting values related to music content in relation to the user of the second user account, the electronic device 100 may determine that the second content application is executed.

Referring to FIG. 22, the electronic device 100 may output the first home screen 1600. Upon receiving speech uttered by a user, the electronic device 100 may output text 2210 related to the speech uttered by the user based on the result of processing the speech received from the server 400.

The electronic device 100 may determine that the speech uttered by the user is related to a command for recommending video content based on the speech processing result received from the server 400. The command for recommending video content may be a command using information on the user.

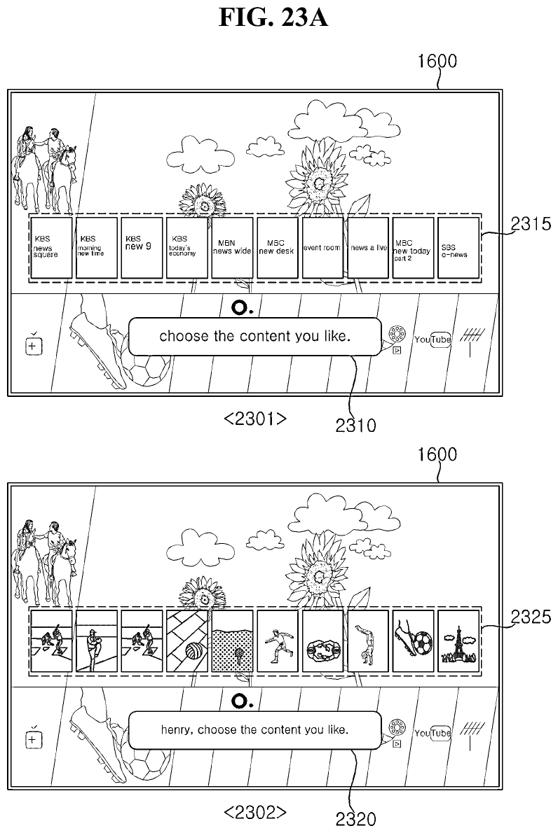

Referring to reference numeral 2301 in FIG. 23A, the electronic device 100 may output a second response 2310 that does not include a user indicator and indicates recommendation of video content. For example, when no voice ID has been registered in the user account of the user who has uttered the speech while being logged in to the server 400 with the first user account, the user who has uttered the speech is not a user preset to use a voice ID, or the user who has uttered the speech is related to the currently logged-in first user account, the electronic device 100 may output the second response 2310 that does not include a user indicator.

The electronic device 100 may obtain information on the user of the first user account from the storage 140 and/or the server 400. The electronic device 100 may output a recommended content list 2315 related to the user of the first user account based on the information on the user obtained in relation to the first user account. For example, if a history of viewing news content is stored in the storage 140 of the electronic device 100 or the preferred genre is set to news in the server 400 in relation to the user of the first user account, the recommended content list 2315 related to the user of the first user account may include news content.

Referring to reference numeral 2302 in FIG. 23A, if use of a voice ID-related function is activated for the second user account of the user who has uttered the speech and the second user account is different from the currently logged-in first user account, the electronic device 100 may switch the user account logged in to the server 400 from the currently logged-in first user account to the second user account of the user who has uttered the speech. Additionally, the electronic device 100 may output a first response 2320 that includes a user indicator and notifies of recommendation of video content.

The electronic device 100 may obtain information on the user of the second user account from the storage 140 and/or the server 400. The electronic device 100 may output a recommended content list 2325 related to the user of the second user account based on the information on the user acquired in relation to the second user account. For example, if a history of viewing sports content is stored in the storage 140 of the electronic device 100 or if a preferred genre is set to sports in the server 400 in relation to the user of the second user account, the recommended content list 2325 related to the user of the second user account may include sports content.

Referring to reference numeral 2303 in FIG. 23B, the electronic device 100 may output a second response 2330 that does not include a user indicator and notifies of recommendation of video content. For example, the electronic device 100 may output the second response 2330 that does not include a user indicator when no voice ID has been registered in the user account of the user who has uttered speech, or the user who has uttered the speech is not a preset user set to use a voice ID in a state in which there is no user account logged in to the server 400.

The electronic device 100 may obtain a history of using the electronic device 100 from the storage 140 and/or the server 400, regardless of a user account, in a state in which there is no user account logged in to the server 400. The electronic device 100 may output a recommended content list 2335 based on the history of using the electronic device 100 obtained regardless of the user account.

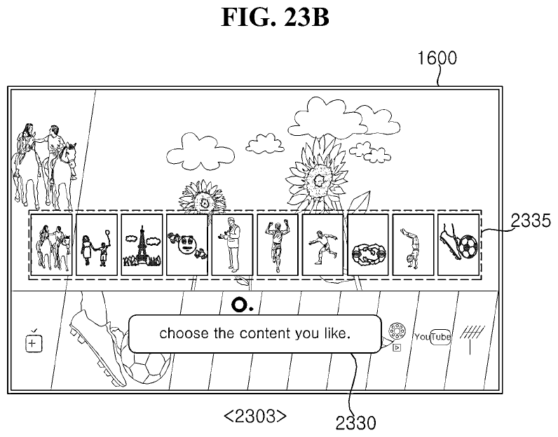

Referring to FIG. 24, the electronic device 100 may output the first home screen 1600. Upon receiving speech uttered by a user, the electronic device 100 may output text 2410 related to the speech uttered by the user based on a speech processing result received from the server 400. The electronic device 100 may determine that the speech uttered by the user is related to a command for executing a specific OTT service application based on the speech processing result received from the server 400. Here, the OTT service application may be an application linked to the user account.

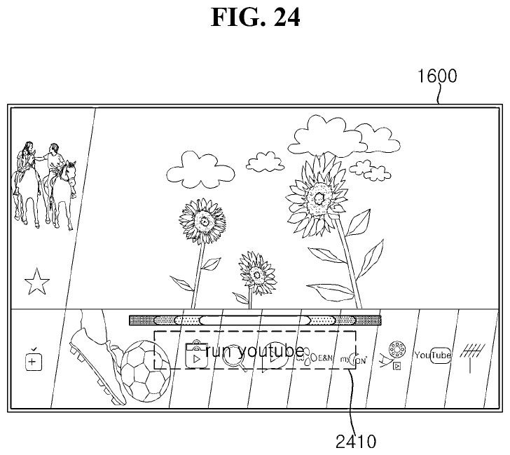

Referring to reference numeral 2501 in FIG. 25, the electronic device 100 may execute the specific OTT service application. Here, the electronic device 100 may access a specific OTT service using a first OTT service account related to the first user account logged in to the server 400. For example, when no voice ID has been registered in the user account of the user who has uttered the speech, the user who has uttered the speech is not a user preset to use a voice ID, or the user who has uttered the speech is related to the currently logged-in first user account, the electronic device 100 may access the specific OTT service using the first OTT service account related to the first user account.

The electronic device 100 may output an OTT service screen 2510 related to the first OTT service account. The OTT service screen 2510 related to the first OTT service account may include an object 2511 representing the first OTT service account, an object 2515 with respect to content related to the first OTT service account, etc.

Meanwhile, the electronic device 100 may provide an audio UI 2513 through the OTT service screen 2510 based on execution of the specific OTT service application according to the speech uttered by the user. For example, the audio UI 2513 may be a user interface that displays numbers mapped to content related to the first OTT service account. When speech is input to select one of the numbers mapped to content, the electronic device 100 may output content related to the selected number through the display 180.

Referring to reference numeral 2502 in FIG. 25, the electronic device 100 may execute a specific OTT service application. The electronic device 100 may access a specific OTT service using a second OTT service account related to the second user account that is different from the first user account. For example, when use of a voice ID-related function is activated for the second user account of the user who has uttered speech, and the second user account is different from the currently logged-in first user account, the electronic device 100 may switch the user account logged in to the server 400 from the currently logged-in first user account to the second user account of the user who has uttered the speech. Additionally, the electronic device 100 may access the specific OTT service using the second OTT service account related to the second user account logged in to the server 400.

The electronic device 100 may output an OTT service screen 2520 related to the second OTT service account. The OTT service screen 2520 related to the second OTT service account may include an object 2521 representing the second OTT service account, an object 2525 with respect to content related to the second OTT service account, etc.

Meanwhile, the electronic device 100 may log in to the server 400 with a user account according to the speech uttered by the user and provide an audio UI 2523 through the OTT service screen 2520 based on execution of a specific OTT service application.

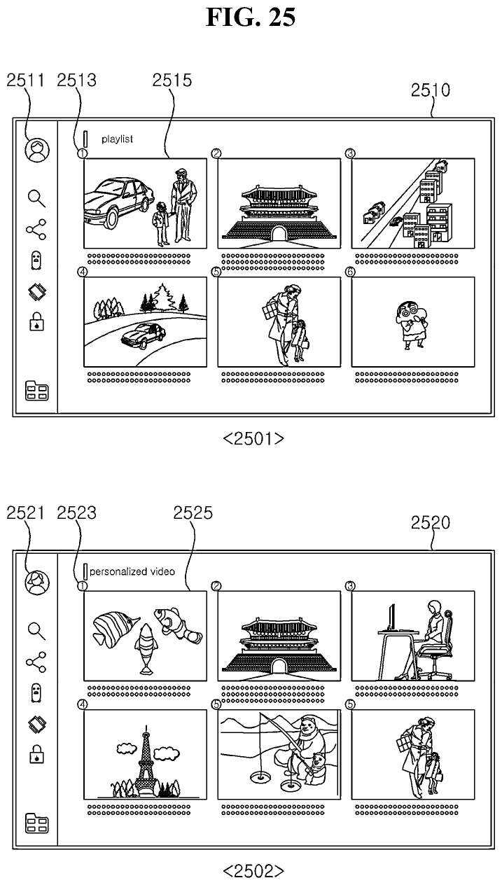

Referring to FIG. 26, the electronic device 100 may log in to the server 400 with a user account according to an input different from speech. The electronic device 100 may output a login screen 2600 using an input different from speech. The login screen 2600 using an input different from speech may include objects 2610, 2620, and 2630 related to various input methods different from speech. The user may select a method of logging in to the server 400 by selecting one of the objects 2610, 2620, and 2630 related to various input methods using a pointer 205.

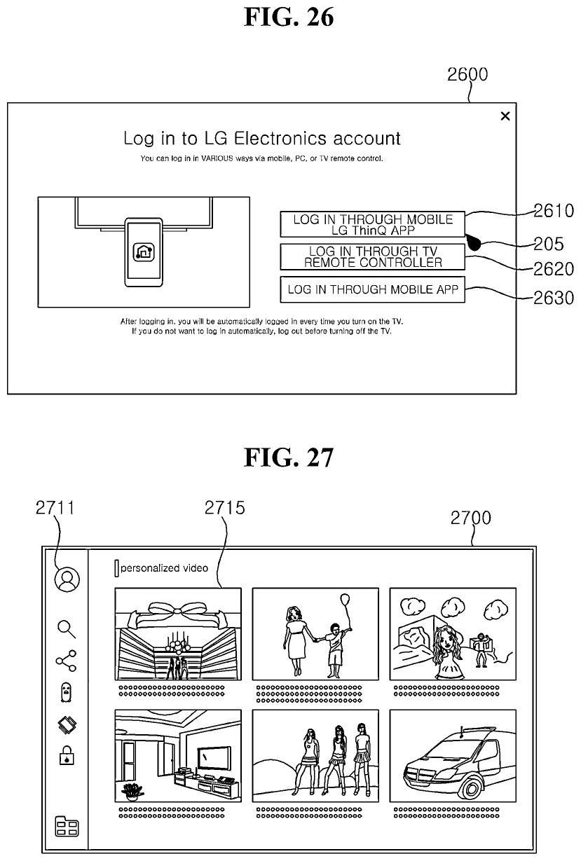

Referring to FIG. 27, the electronic device 100 may execute a specific OTT service application while logging in to the server 400 with a third user account according to the input different from speech. Here, the electronic device 100 may access a specific OTT service using a third OTT service account related to the third user account logged in to the server 400.

The electronic device 100 may output an OTT service screen 2700 related to the third OTT service account. The OTT service screen 2700 related to the third OTT service account may include an object 2711 representing the third OTT service account, an object 2715 with respect to content related to the third OTT service account, etc.

Further, based on logging in to the server 400 with the third user account according to the input different from speech, the audio UI may not be provided.

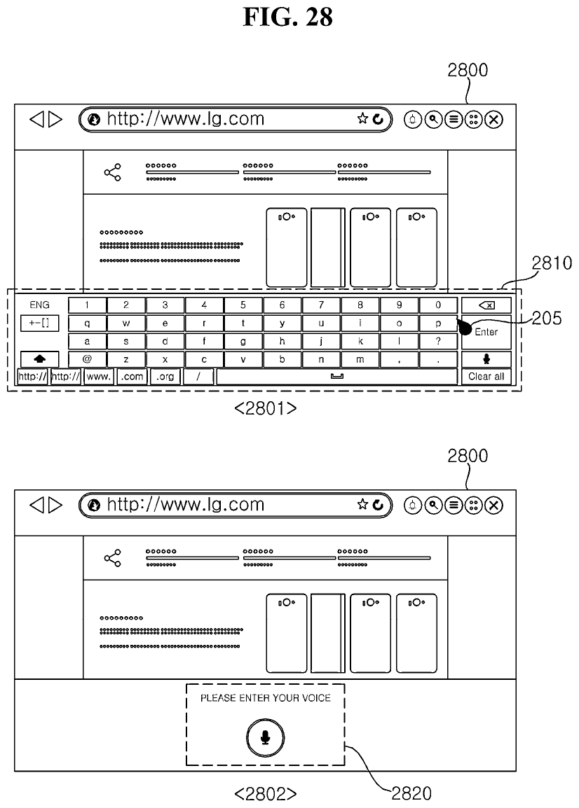

Referring to reference numeral 2801 in FIG. 28, the electronic device 100 may output a search screen 2800 in response to execution of a search function. For example, the electronic device 100 may execute a search function for searching for an Internet address. Here, the electronic device 100 may provide a general UI 2810 (e.g., a virtual keyboard) through the search screen 2800 based on the user account currently logged in to the server 400 according to an input different from speech. Here, the virtual keyboard may be a software component through which characters are input without requiring physical keys.

Referring to reference numeral 2802 in FIG. 28, the electronic device 100 may provide an audio UI 2820 through the search screen 2800 based on the user account currently logged in to the server 400 according to speech.

As described above, according to at least one embodiment of the present disclosure, it is possible to register identification information on user voice in a user account.

Additionally, according to at least one embodiment of the present disclosure, it is possible to identify a user based on user voice.

Additionally, according to at least one embodiment of the present disclosure, it is possible to log in to an account of a user identified based on user voice.

Additionally, according to at least one embodiment of the present disclosure, it is possible to accurately notify the user of switching of a logged-in user account.

Additionally, according to at least one embodiment of the present disclosure, it is possible to use setting values optimized for a logged-in user account.

Additionally, according to at least one embodiment of the present disclosure, it is possible to provide a user interface optimized for an input method used by a user.

Referring to FIG. 1 to FIG. 28, the electronic device according to an aspect of the present disclosure includes a network interface configured to communicate with a server, a user input interface configured to transmit a signal related to an input, and a controller, wherein the controller is configured to, upon receiving a speech signal related to input speech, determine whether a user who has uttered the input speech is related to a first user account logged in to the server, log in to the server with a second user account related to the user who has uttered the input speech based on the user who has uttered the input speech not being related to the first user account, and update setting values preset for the electronic device to setting values related to the second user account based on logging in to the server with the second user account.

Additionally, according to one aspect of the present disclosure, the electronic device may further include a memory configured to store setting values related to predetermined user accounts, wherein the controller obtains setting values related to the second user account from the memory.

Additionally, according to one aspect of the present disclosure, the server may store setting values related to a predetermined user account, and the controller may obtain setting values related to the second user account from the server.

Additionally, according to one aspect of the present disclosure, the server may store the setting values for each of a plurality of pieces of device identification information mapped to the predetermined user account, and the controller may transmit device identification information related to the electronic device to the server and obtain, from the server, setting values related to the second user account and mapped to the device identification information related to the electronic device from the server.

In addition, according to one aspect of the present disclosure, the electronic device may further include a memory configured to store a user list containing at least one piece of user identification information related to a user account with a history of logging in to the server, wherein the controller transmits the user list to the server along with data containing the speech signal, and compares first user identification information related to the first user account with second user identification information related to the input speech and received from the server to determine whether the user who has uttered the input speech is related to the first user account.

Additionally, according to one aspect of the present disclosure, the memory may store a history of using the electronic device for each user account, and based on the input speech being related to execution of one of a plurality of applications, the controller may determine an application to be executed in response to the input speech based on a first history related to the first user identification information stored in the memory based on logging in to the server with the first user account, and determine an application to be executed in response to the input speech based on a second history related to the second user identification information stored in the memory based on logging in to the server with the second user account.

In addition, according to one aspect of the present disclosure, the electronic device may further include a display, wherein the controller provides a first user interface related to the speech through the display based on logging in to the server based on the input speech and provides a second user interface different from the first user interface through the display based on logging in to the server based on a predetermined input different from the input speech.

Additionally, according to one aspect of the present disclosure, the first user interface may include a number mapped to an object included in a screen displayed through the display, and the controller may determine that an input for selecting the object mapped to the number is received upon receiving input speech related to the number.

The system 10 according to one aspect of the present disclosure includes an electronic device and a server, wherein the electronic device is configured to transmit data including a speech signal related to input speech uttered by a user to the server, determine whether the user who has uttered the input speech is related to a first user account logged in to the server based on a result of processing the speech signal received from the server, log in to the server with a second user account related to the user who has uttered the input speech based on the user who has uttered the input speech not being related to the user account logged in to the server, and update setting values preset for the electronic device to setting values related to the second user account based on logging in to the server with the second user account, and the server is configured to generate identification information related to the speech signal included in the data received from the electronic device, determine predetermined identification information related to the identification information related to the speech signal from among identification information mapped to user identification information related to user accounts, stored in a database of the server, and transmit a result of processing the speech signal including predetermined user identification information mapped to the predetermined identification information to the electronic device.

Additionally, according to one aspect of the present disclosure, the electronic device may obtain setting values related to the second user account from a memory in which setting values related to predetermined user accounts are stored.

Additionally, according to one aspect of the present disclosure, the database may store setting values related to predetermined user accounts, and the electronic device may obtain the setting values related to the second user account from the server.

Additionally, according to one aspect of the present disclosure, the database may store the setting values for a plurality of pieces of device identification information mapped to the predetermined user accounts, and the electronic device may transmit device identification information related to the electronic device to the server and obtain, from the server, the setting values related to the second user account mapped to the device identification information related to the electronic device.

In addition, according to one aspect of the present disclosure, the electronic device may include a memory configured to store a user list containing at least one piece of user identification information and related to a user account having a history of logging in to the server, the electronic device may transmit the user list along with the data including the speech signal to the server, and the server may search the database for user identification information related to the user list and determine whether user identification information mapped to the identification information related to the user list is related to identification information regarding the speech signal.

In addition, according to one aspect of the present disclosure, the memory may store a history of using the electronic device for each user account and, based on the input speech being related to execution of one of a plurality of applications, the electronic device may determine an application to be executed in response to the input speech based on a first history related to first user identification information stored in the memory based on logging in to the server with the first user account, and determine an application to be executed in response to the input speech based on a second history related to second user identification information stored in the memory based on logging in to the server with the second user account.

Additionally, according to one aspect of the present disclosure, the electronic device may provide a first user interface related to the speech through a display based on logging in to the server based on the input speech and provide a second user interface different from the first user interface through the display based on logging in to the server based on a predetermined input different from the input speech.

The attached drawings are only for easy understanding of the embodiments disclosed in this specification, and the technical idea disclosed in this specification is not limited by the attached drawings, and all changes, equivalents, and changes included in the technical scope of the present disclosure are not limited thereby.

Meanwhile, the operating method of the present disclosure may be implemented as processor-readable code on a processor-readable recording medium. Processor-readable recording media include all types of recording devices that store data that may be read by a processor. Examples of processor-readable recording media include a ROM, a RAM, a CD-ROM, a magnetic tape, a floppy disk, and an optical data storage device, and also include those implemented in the form of a carrier wave, such as transmission through the Internet. Additionally, a processor-readable recording medium is distributed in a computer system connected to a network, and thus processor-readable code may be stored and executed in a distributed manner.

The electronic device and the system including the same according to the present disclosure have the following effects.

According to at least one embodiment of the present disclosure, it is possible to register identification information on user voice in a user account.

According to at least one embodiment of the present disclosure, it is possible to identify a user based on user voice.

According to at least one embodiment of the present disclosure, it is possible to log in to an account of a user identified based on user voice.

According to at least one embodiment of the present disclosure, it is possible to accurately notify the user of switching of a logged-in user account.

According to at least one embodiment of the present disclosure, it is possible to use setting values optimized for a logged-in user account.

According to at least one embodiment of the present disclosure, it is possible to provide a user interface optimized for an input method used by a user.

Although the preferred embodiments of the present disclosure have been disclosed for illustrative purposes, those skilled in the art will appreciate that various modifications, additions and substitutions are possible, without departing from the scope of the disclosure as disclosed in the accompanying claims.

What is claimed is:

1. An electronic device comprising:
a network interface configured to communicate with a server;
a user input interface configured to transmit a signal related to an input; and
a controller,
wherein the controller is configured to:
upon receiving a speech signal related to input speech, determine whether a user who has uttered the speech is related to a first user account logged in to the server;
log in to the server with a second user account related to the user who has uttered the input speech based on the user who has uttered the input speech not being related to the first user account; and
update setting values preset for the electronic device to setting values related to the second user account based on logging in to the server with the second user account.

2. The electronic device of claim 1, further comprising a memory configured to store setting values related to predetermined user accounts,
wherein the controller is configured to obtain the setting values related to the second user account from the memory.

3. The electronic device of claim 1, wherein the server is configured to store setting values related to predetermined user accounts, and
the controller is configured to obtain the setting values related to the second user account from the server.

4. The electronic device of claim 3, wherein the server is configured to store the setting values for each of a plurality of pieces of device identification information mapped to the predetermined user accounts, and
the controller is configured to:
transmit device identification information related to the electronic device to the server and
obtain, from the server, the setting values related to the second user account and mapped to the device identification information related to the electronic device.

5. The electronic device of claim 1, further comprising a memory configured to store a user list including at least one piece of user identification information related to a user account with a history of logging in to the server,
wherein the controller is configured to:
transmit the user list to the server along with data including the speech signal, and
compare first user identification information related to the first user account with second user identification information related to the input speech and received from the server to determine whether the user who has uttered the input speech is related to the first user account.

6. The electronic device of claim 5, wherein the memory is configured to store a history of using the electronic device for each user account, and
based on the input speech being related to execution of one of a plurality of applications, the controller is configured to:
determine an application to be executed in response to the input speech based on a first history related to the first user identification information stored in the memory based on logging in to the server with the first user account, and
determine the application to be executed in response to the input speech based on a second history related to the second user identification information stored in the memory based on logging in to the server with the second user account.

7. The electronic device of claim 1, further comprising a display,
wherein the controller is configured to:
provide a first user interface related to the speech through the display based on logging in to the server based on the input speech, and
provide a second user interface different from the first user interface through the display based on logging in to the server based on a predetermined input different from the input speech.

8. The electronic device of claim 7, wherein the first user interface includes a number mapped to an object included in a screen displayed through the display, and
the controller is configured to determine that an input for selecting the object mapped to the number is received upon receiving input speech related to the number.

9. A system comprising:
an electronic device; and
a server,
wherein the electronic device is configured to:
transmit data including a speech signal related to input speech uttered by a user to the server;
determine whether the user who has uttered the input speech is related to a first user account logged in to the server based on a result of processing the speech signal received from the server;
log in to the server with a second user account related to the user who has uttered the input speech based on the user who has uttered the input speech not being related to the user account logged in to the server; and
update setting values preset for the electronic device to setting values related to the second user account based on logging in to the server with the second user account, and
the server is configured to:
generate identification information related to the speech signal included in the data received from the electronic device;
determine predetermined identification information related to the identification information related to the speech signal from among identification information mapped to user identification information related to user accounts, stored in a database of the server; and
transmit the result of processing the speech signal including predetermined user identification information mapped to the predetermined identification information to the electronic device.

10. The system of claim 9, wherein the electronic device is configured to obtain the setting values related to the second user account from a memory in which setting values related to predetermined user accounts are stored.

11. The system of claim 9, wherein the database stores setting values related to predetermined user accounts, and
the electronic device is configured to obtain the setting values related to the second user account from the server.

12. The system of claim 11, wherein the database stores the setting values for a plurality of pieces of device identification information mapped to the predetermined user accounts, and
the electronic device is configured to:
transmit device identification information related to the electronic device to the server and
obtain, from the server, the setting values related to the second user account mapped to the device identification information related to the electronic device.

13. The system of claim 9, wherein the electronic device comprises a memory configured to store a user list including at least one piece of user identification information related to a user account having a history of logging in to the server,
wherein the electronic device is configured to transmit the user list along with the data including the speech signal to the server, and
the server is configured to:
search the database for user identification information related to the user list, and
determine whether identification information mapped to the user identification information related to the user list is related to the identification information related to the speech signal.

14. The system of claim 13, wherein the memory stores a history of using the electronic device for each user account, and
based on the input speech being related to execution of one of a plurality of applications, the electronic device is configured to:
determine an application to be executed in response to the input speech based on a first history related to first user identification information stored in the memory, based on logging in to the server with the first user account, and
determine the application to be executed in response to the input speech based on a second history related to second user identification information stored in the memory, based on logging in to the server with the second user account.

15. The system of claim 9, wherein the electronic device is configured to:
provide a first user interface related to the speech through a display based on logging in to the server based on the input speech, and
provide a second user interface different from the first user interface through the display based on logging in to the server based on a predetermined input different from the input speech.
